(19) United States
(12) Patent Application Publication
(10) Pub. No.: US 2017/0005981 A1
(43) Pub. Date: Jan. 5, 2017

(54) ADDRESS IDENTIFIER ALLOCATION METHOD, RELATED DEVICE, AND SYSTEM

(71) Applicant: Huawei Technologies Co., Ltd., Shenzhen (CN)

(72) Inventors: Bingfu Wang, Shenzhen (CN); Chenghui Peng, Munich (DE); Rui Ni, Shenzhen (CN)

(21) Appl. No.: 15/266,806

(22) Filed: Sep. 15, 2016

Related U.S. Application Data
(63) Continuation of application No. PCT/CN2014/073500, filed on Mar. 17, 2014.

(51) Int. Cl. H04L 29/12; H04L 12/715; H04L 12/741

(52) U.S. Cl. CPC H04L 61/2046; H04L 45/74; H04L 45/64; H04W 84/042

(57) ABSTRACT

An embodiment of the present invention provides an address identifier allocation method, a related device, and a system. The address identifier allocation method may include: receiving, by a control plane node, a first service request message that is from a first user plane access node and that carries a first user terminal identifier; searching, by the control plane node, a stored valid address allocation record for a valid address allocation record that matches the first user terminal identifier; if a first valid address allocation record that matches the first user terminal identifier is found in the stored valid address allocation record, allocating a first address identifier recorded in the first valid address allocation record to a first user terminal indicated by the first user terminal identifier; The solution of the present invention helps reduce complexity of allocation and management of an address identifier of a user terminal.

### CROSS-REFERENCE TO RELATED APPLICATIONS

This application is a continuation of International Patent Application No. PCT/CN2014/073500, filed on Mar. 17, 2014, which is hereby incorporated by reference in its entirety.

### TECHNICAL FIELD

The present invention relates to the field of communications technologies, and specifically, to an address identifier allocation method, a related device, and a communications system.

### BACKGROUND

In recent years, Wireless Fidelity (WiFi, wireless fidelity) terminals explosively increase. A WiFi terminal is, for example, a mobile phone, a tablet computer, or a notebook computer. A study from a professional organization shows that WiFi is currently a main manner of carrying wireless network data traffic, a traffic share of which has even exceeded that of a wireless cellular technology of a mobile communications network. For a technical purpose of data offloading and an economic purpose of business competition, telecommunications operators choose a “cellular+WiFi” heterogeneous access network convergence solution.

For example, in an existing heterogeneous access network convergence solution, an address identifier (an address identifier is, for example, an Internet Protocol (IP, Internet Protocol) address) of a user terminal is independently managed in each network. For example, in the “cellular+WiFi” heterogeneous access network convergence solution, an address identifier of a user terminal is independently allocated and managed in a cellular network and in WiFi.

### SUMMARY

The present invention provides an address identifier allocation method, a related device, and a system, to reduce complexity of allocation and management of an address identifier of a user terminal.

A first aspect of the present invention provides an address identifier allocation method, which may include:

receiving, by a control plane node, a first service request message that is from a first user plane access node and that carries a first user terminal identifier, where the first service request message is an access request message or a handover request message;

searching, by the control plane node, a stored valid address allocation record for a valid address allocation record that matches the first user terminal identifier, and if a first valid address allocation record that matches the first user terminal identifier is found in the stored valid address allocation record, allocating a first address identifier recorded in the first valid address allocation record to a first user terminal indicated by the first user terminal identifier; and

sending, to the first user plane access node by the control plane node, a first request response message in response to the first service request message, where the first request response message carries the first address identifier, so that the first user plane access node notifies the first user terminal of the first address identifier.

With reference to the first aspect, in a first possible implementation manner of the first aspect, the first valid address allocation record further records a user plane access node identifier, where a user plane access node indicated by the user plane access node identifier and the first user plane access node belong to networks of a same standard, or a user plane access node indicated by the user plane access node identifier and the first user plane access node belong to networks of different standards.

With reference to the first aspect or the first possible implementation manner of the first aspect, in a second possible implementation manner of the first aspect, the first user terminal is a multimode user terminal.

With reference to the first aspect, or the first possible implementation manner of the first aspect, or the second possible implementation manner of the first aspect, in a third possible implementation manner of the first aspect,

after the allocating a first address identifier recorded in the first valid address allocation record to a first user terminal indicated by the first user terminal identifier, the method further includes: determining, by the control plane node, a first routing rule corresponding to the first address identifier and a gateway router; and notifying, by the control plane node, the gateway router of the first routing rule.

With reference to the third possible implementation manner of the first aspect, in a fourth possible implementation manner of the first aspect,

after the allocating a first address identifier recorded in the first valid address allocation record to a first user terminal indicated by the first user terminal identifier, the method further includes: determining, by the control plane node, N1 routing rules corresponding to the first address identifier and N1 OpenFlow switches; and sending, by the control plane node, the N1 routing rules to the N1 OpenFlow switches, where a routing rule sent to each OpenFlow switch of the N1 OpenFlow switches is a routing rule in the N1 routing rules that is in a one-to-one correspondence with each OpenFlow switch, the N1 OpenFlow switches are OpenFlow switches located on a transmission path between the gateway router and the first user plane access node, and N1 is a positive integer.

With reference to the first aspect, or the first possible implementation manner of the first aspect, or the second possible implementation manner of the first aspect, or the third possible implementation manner of the first aspect, or the fourth possible implementation manner of the first aspect, in a fifth possible implementation manner of the first aspect, after the allocating a first address identifier recorded in the first valid address allocation record to a first user terminal indicated by the first user terminal identifier, the method further includes: determining, by the control plane node, a second routing rule corresponding to the first address identifier and the first user plane access node; and notifying, by the control plane node, the first user plane access node of the second routing, rule.

With reference to the first aspect, or the first possible implementation manner of the first aspect, or the second possible implementation manner of the first aspect, or the third possible implementation manner of the first aspect, or the fourth possible implementation manner of the first aspect, or the fifth possible implementation manner of the first aspect, in a sixth possible implementation manner of the first aspect, after the sending, to the first user plane access node by the control plane node, a first request response message in response to the first service request message, the method further includes:

receiving, by the control plane node, a second service request message that is from a second user plane access node and that carries the first user terminal identifier, where the second service request message is an access request message or a handover request message, and the second user plane access node and the first user plane access node belong to networks of different standards;

if the first valid address allocation record that matches the first user terminal identifier is found in the stored valid address allocation record, allocating, by the control plane node, the first address identifier recorded in the first valid address allocation record to the first user terminal; and

sending, to the second user plane access node by the control plane node, a second request response message in response to the second service request message, where the second request response message carries the first address identifier, so that the second user plane access node notifies the first user terminal of the first address identifier.

With reference to the first aspect, or the first possible implementation manner of the first aspect, or the second possible implementation manner of the first aspect, or the third possible implementation manner of the first aspect, or the fourth possible implementation manner of the first aspect, or the fifth possible implementation manner of the first aspect, or the sixth possible implementation manner of the first aspect, in a seventh possible implementation manner of the first aspect,

the method further includes: if no valid address allocation record that matches the first user terminal identifier is found in the stored valid address allocation record, allocating, by the control plane node, a second address identifier to the first user terminal, and sending, to the first user plane access node by the control plane node, a second request response message in response to the first service request message, where the second request response message carries the second address identifier, so that the first user plane access node notifies the first user terminal of the second address identifier.

With reference to the seventh possible implementation manner of the first aspect, in an eighth possible implementation manner of the first aspect, the method further includes: generating a second valid address allocation record according to the first user terminal identifier and the second address identifier, and storing the second valid address allocation record, where the second valid address allocation record records the first user terminal identifier, the second address identifier, and a user plane access node identifier corresponding to the first user plane access node, or the second valid address allocation record records the first user terminal identifier and the second address identifier.

With reference to the seventh possible implementation manner of the first aspect or the eighth possible implementation manner of the first aspect, in a ninth possible implementation manner of the first aspect, after the allocating, by the control plane node, a second address identifier to the first user terminal, the method further includes: determining, by the control plane node, a third routing rule corresponding to the second address identifier and the gateway router; and notifying, by the control plane node, the gateway router of the third routing rule.

With reference to the ninth possible implementation manner of the first aspect, in a tenth possible implementation manner of the first aspect,

after the allocating, by the control plane node, a second address identifier to the first user terminal, the method further includes: determining, by the control plane node, N2 routing rules corresponding to the second address identifier and the N2 OpenFlow switches; and sending, by the control plane node, the N2 routing rules to the N2 OpenFlow switches, where a routing rule sent to each OpenFlow switch of the N2 OpenFlow switches is a routing rule in the N2 routing rules that is in a one-to-one correspondence with each OpenFlow switch, the N2 OpenFlow switches are the OpenFlow switches located on the transmission path between the gateway router and the first user plane access node, and N2 is a positive integer.

With reference to the seventh possible implementation manner of the first aspect, or the eighth possible implementation manner of the first aspect, or the ninth possible implementation manner of the first aspect, or the tenth possible implementation manner of the first aspect, in an eleventh possible implementation manner of the first aspect, after the allocating, by the control plane node, a second address identifier to the first user terminal, the method further includes:

determining, by the control plane node, a fourth routing rule corresponding to the second address identifier and the first user plane access node; and notifying, by the control plane node, the first user plane access node of the fourth routing rule.

With reference to the seventh possible implementation manner of the first aspect, or the eighth possible implementation manner of the first aspect, or the ninth possible implementation manner of the first aspect, or the tenth possible implementation manner of the first aspect, or the eleventh possible implementation manner of the first aspect, in a twelfth possible implementation manner of the first aspect, after the sending, to the first user plane access node by the control plane node, a second request response message in response to the first service request message, the method further includes:

receiving, by the control plane node, a second service request message that is from a third user plane access node and that carries the first user terminal identifier, where the second service request message is an access request message or a handover request message, and the third user plane access node and the first user plane access node belong to networks of a same standard or different standards;

if the second valid address allocation record that matches the first user terminal identifier is found in the stored valid address allocation record, allocating, by the control plane node, the second address identifier recorded in the second valid address allocation record to the first user terminal; and

sending, to the third user plane access node by the control plane node, a third request response message in response to the second service request message, where the third request response message carries the second address identifier, so that the third user plane access node notifies the first user terminal of the second address identifier.

With reference to the seventh possible implementation manner of the first aspect, or the eighth possible implementation manner of the first aspect, or the ninth possible implementation manner of the first aspect, or the tenth possible implementation manner of the first aspect, or the eleventh possible implementation manner of the first aspect, or the twelfth possible implementation manner of the first aspect, in a thirteenth possible implementation manner of the first aspect, the second address identifier includes at least one of the following address identifiers: an Internet Protocol address, a Media Access Control address, and a network-wide unique user name.

With reference to the first aspect, or the first possible implementation manner of the first aspect, or the second possible implementation manner of the first aspect, or the third possible implementation manner of the first aspect, or the fourth possible implementation manner of the first aspect, or the fifth possible implementation manner of the first aspect, or the sixth possible implementation manner of the first aspect, or the seventh possible implementation manner of the first aspect, or the eighth possible implementation manner of the first aspect, or the ninth possible implementation manner of the first aspect, or the tenth possible implementation manner of the first aspect, or the eleventh possible implementation manner of the first aspect, or the twelfth possible implementation manner of the first aspect, or the thirteenth possible implementation manner of the first aspect, in a fourteenth possible implementation manner of the first aspect, the first address identifier includes at least one of the following address identifiers: an Internet Protocol address, a Media Access Control address, and a network-wide unique user name.

A second aspect of the present invention provides a control plane node, which may include:

a receiving unit, configured to receive a first service request message that is from a first user plane access node and that carries a first user terminal identifier, where the first service request message is an access request message or a handover request message;

an allocation unit, configured to: search a stored valid address allocation record for a valid address allocation record that matches the first user terminal identifier, and if a first valid address allocation record that matches the first user terminal identifier is found in the stored valid address allocation record, allocate a first address identifier recorded in the first valid address allocation record to a first user terminal indicated by the first user terminal identifier; and a sending unit, configured to send, to the first user plane access node, a first request response message in response to the first service request message, where the first request response message carries the first address identifier, so that the first user plane access node notifies the first user terminal of the first address identifier.

With reference to the second aspect, in a first possible implementation manner of the second aspect, the first valid address allocation record further records a user plane access node identifier, where a user plane access node indicated by the user plane access node identifier and the first user plane access node belong to networks of a same standard, or a user plane access node indicated by the user plane access node identifier and the first user plane access node belong to networks of different standards.

With reference to the second aspect or the first possible implementation manner of the second aspect, in a second possible implementation manner of the second aspect,

the control plane node further includes a first routing control unit, configured to: after the allocation unit allocates the first address identifier recorded in the first valid address allocation record to the first user terminal indicated by the first user terminal identifier, determine a first routing rule corresponding to the first address identifier and a gateway router, and notify the gateway router of the first routing rule.

With reference to the second possible implementation manner of the second aspect, in a third possible implementation manner of the second aspect, the first routing control unit is further configured to: after the allocation unit allocates the first address identifier recorded in the first valid address allocation record to the first user terminal indicated by the first user terminal identifier, determine N1 routing rules corresponding to the first address identifier and N1 OpenFlow switches, and send the N1 routing rules to the N1 OpenFlow switches, where a routing rule sent to each OpenFlow switch of the N1 OpenFlow switches is a routing rule in the N1 routing rules that is in a one-to-one correspondence with each OpenFlow switch, the N1 OpenFlow switches are OpenFlow switches located on a transmission path between the gateway router and the first user plane access node, and N1 is a positive integer.

With reference to the second aspect, or the first possible implementation manner of the second aspect, or the second possible implementation manner of the second aspect, or the third possible implementation manner of the second aspect, in a fourth possible implementation manner of the second aspect, the first routing control unit is further configured to: after the allocation unit allocates the first address identifier recorded in the first valid address allocation record to the first user terminal indicated by the first user terminal identifier, determine a second routing rule corresponding to the first address identifier and the first user plane access node, and notify the first user plane access node of the second routing rule.

With reference to the second aspect, or the first possible implementation manner of the second aspect, or the second possible implementation manner of the second aspect, or the third possible implementation manner of the second aspect, or the fourth possible implementation manner of the second aspect, in a fifth possible implementation manner of the second aspect,

the receiving unit is further configured to: after the sending unit sends, to the first user plane access node, the first request response message in response to the first service request message, receive a second service request message that is from a second user plane access node and that carries the first user terminal identifier, where the second service request message is an access request message or a handover request message, and the second user plane access node and the first user plane access node belong to networks of different standards;

the allocation unit is further configured to: if the first valid address allocation record that matches the first user terminal identifier is found in the stored valid address allocation record, allocate the first address identifier recorded in the first valid address allocation record to the first user terminal; and

the sending unit is further configured to send, to the second user plane access node, a second request response message in response to the second service request message, where the second request response message carries the first address identifier, so that the second user plane access node notifies the first user terminal of the first address identifier.

With reference to the second aspect, or the first possible implementation manner of the second aspect, or the second possible implementation manner of the second aspect, or the third possible implementation manner of the second aspect, or the fourth possible implementation manner of the second aspect, or the fifth possible implementation manner of the second aspect, in a sixth possible implementation manner of the second aspect,

the allocation unit is further configured to: if no valid address allocation record that matches the first user terminal identifier is found in the stored valid address allocation record, allocate a second address identifier to the first user terminal; and

the sending unit is further configured to send, to the first user plane access node, a second request response message in response to the first service request message, where the second request response message carries the second address identifier, so that the first user plane access node notifies the first user terminal of the second address identifier.

With reference to the sixth possible implementation manner of the second aspect, in a seventh possible implementation manner of the second aspect, the control plane node further includes:

a record maintenance unit, configured to: generate a second valid address allocation record according to the first user terminal identifier and the first address identifier, and store the second valid address allocation record, where the second valid address allocation record records the first user terminal identifier, the first address identifier, and a user plane access node identifier corresponding to the first user plane access node, or the second valid address allocation record records the first user terminal identifier and the first address identifier.

With reference to the fifth possible implementation manner of the second aspect, or the sixth possible implementation manner of the second aspect, or the seventh possible implementation manner of the second aspect, in an eighth possible implementation manner of the second aspect, the control plane node further includes a second routing control unit, configured to: after the allocation unit allocates the second address identifier to the first user terminal, determine a third routing rule corresponding to the second address identifier and the gateway router, and notify the gateway router of the third routing rule.

With reference to the eighth possible implementation manner of the second aspect, in a ninth possible implementation manner of the second aspect, the second routing control unit is further configured to: after the allocation unit allocates the second address identifier to the first user terminal, determine N2 routing rules corresponding to the second address identifier and the N2 OpenFlow switches, and send the N2 routing rules to the N2 OpenFlow switches, where a routing rule sent to each OpenFlow switch of the N2 OpenFlow switches is a routing rule in the N2 routing rules that is in a one-to-one correspondence with each OpenFlow switch, the N2 OpenFlow switches are the OpenFlow switches located on the transmission path between the gateway router and the first user plane access node, and N2 is a positive integer.

With reference to the sixth possible implementation manner of the second aspect, or the seventh possible implementation manner of the second aspect, or the eighth possible implementation manner of the second aspect, or the ninth possible implementation manner of the second aspect, in a tenth possible implementation manner of the second aspect, the second routing control unit is further configured to: after the allocation unit allocates the second address identifier to the first user terminal, determine a fourth routing rule corresponding to the second address identifier and the first user plane access node, and notify the first user plane access node of the fourth routing rule.

With reference to the sixth possible implementation manner of the second aspect, or the seventh possible implementation manner of the second aspect, or the eighth possible implementation manner of the second aspect, or the ninth possible implementation manner of the second aspect, or the tenth possible implementation manner of the second aspect, in an eleventh possible implementation manner of the second aspect,

the receiving unit is further configured to: after the sending unit sends, to the first user plane access node, the second request response message in response to the first service request message, receive a second service request message that is from a third user plane access node and that carries the first user terminal identifier, where the second service request message is an access request message or a handover request message, and the third user plane access node and the first user plane access node belong to networks of a same standard or different standards;

the allocation unit is further configured to: if the second valid address allocation record that matches the first user terminal identifier is found in the stored valid address allocation record, allocate the second address identifier recorded in the second valid address allocation record to the first user terminal; and

the sending unit is further configured to send, to the third user plane access node, a third request response message in response to the second service request message, where the third request response message carries the second address identifier, so that the third user plane access node notifies the first user terminal of the second address identifier.

With reference to the sixth possible implementation manner of the second aspect, or the seventh possible implementation manner of the second aspect, or the eighth possible implementation manner of the second aspect, or the ninth possible implementation manner of the second aspect, or the tenth possible implementation manner of the second aspect, or the eleventh possible implementation manner of the second aspect, in a twelfth possible implementation manner of the second aspect, the second address identifier includes at least one of the following address identifiers: an Internet Protocol address, a Media Access Control address, and a network-wide unique user name.

With reference to the second aspect, or the first possible implementation manner of the second aspect, or the second possible implementation manner of the second aspect, or the third possible implementation manner of the second aspect, or the fourth possible implementation manner of the second aspect, or the fifth possible implementation manner of the second aspect, or the sixth possible implementation manner of the second aspect, or the seventh possible implementation manner of the second aspect, or the eighth possible implementation manner of the second aspect, or the ninth possible implementation manner of the second aspect, or the tenth possible implementation manner of the second aspect, or the eleventh possible implementation manner of the second aspect, or the twelfth possible implementation manner of the second aspect, in a thirteenth possible implementation manner of the second aspect, the first address identifier includes at least one of the following address identifiers: an Internet Protocol address, a Media Access Control address, and a network-wide unique user name.

With reference to the second aspect, or the first possible implementation manner of the second aspect, or the second possible implementation manner of the second aspect, or the third possible implementation manner of the second aspect, or the fourth possible implementation manner of the second aspect, or the fifth possible implementation manner of the second aspect, or the sixth possible implementation manner of the second aspect, or the seventh possible implementation manner of the second aspect, or the eighth possible implementation manner of the second aspect, or the ninth possible implementation manner of the second aspect, or the tenth possible implementation manner of the second aspect, or the eleventh possible implementation manner of the second aspect, or the twelfth possible implementation manner of the second aspect, or the thirteenth possible implementation manner of the second aspect, in a fourteenth possible implementation manner of the second aspect, the first user terminal is a multimode user terminal.

A third aspect of the present invention provides a control plane node, where

the control plane node may include at least one bus, at least one processor connected to the bus, and at least one memory connected to the bus; where

by invoking, by using the bus, code stored in the memory, the processor is configured to: receive a first service request message that is from a first user plane access node and that carries a first user terminal identifier, where the first service request message is an access request message or a handover request message;

search a stored valid address allocation record for a valid address allocation record that matches the first user terminal identifier, and if a first valid address allocation record that matches the first user terminal identifier is found in the stored valid address allocation record, allocate a first address identifier recorded in the first valid address allocation record to a first user terminal indicated by the first user terminal identifier; and

send, to the first user plane access node, a first request response message in response to the first service request message, where the first request response message carries the first address identifier, so that the first user plane access node notifies the first user terminal of the first address identifier.

With reference to the third aspect, in a first possible implementation manner of the third aspect, the first valid address allocation record further records a user plane access node identifier, where a user plane access node indicated by the user plane access node identifier and the first user plane access node belong to networks of a same standard, or a user plane access node indicated by the user plane access node identifier and the first user plane access node belong to networks of different standards.

With reference to the third aspect or the first possible implementation manner of the third aspect, in a second possible implementation manner of the third aspect, the first user terminal is a multimode user terminal.

With reference to the third aspect, or the first possible implementation manner of the third aspect, or the second possible implementation manner of the third aspect, in a third possible implementation manner of the third aspect,

by invoking, by using the bus, the code stored in the memory, the processor is further configured to: after allocating the first address identifier recorded in the first valid address allocation record to the first user terminal indicated by the first user terminal identifier, determine a first routing rule corresponding to the first address identifier and a gateway router, and notify the gateway router of the first routing rule.

With reference to the third possible implementation manner of the third aspect, in a fourth possible implementation manner of the third aspect,

by invoking, by using the bus, the code stored in the memory, the processor is further configured to: after allocating the first address identifier recorded in the first valid address allocation record to the first user terminal indicated by the first user terminal identifier, determine N1 routing rules corresponding to the first address identifier and N1 OpenFlow switches, and send the N1 routing rules to the N1 OpenFlow switches, where a routing rule sent to each OpenFlow switch of the N1 OpenFlow switches is a routing rule in the N1 routing rules that is in a one-to-one correspondence with each OpenFlow switch, the N1 OpenFlow switches are OpenFlow switches located on a transmission path between the gateway router and the first user plane access node, and N1 is a positive integer.

With reference to the third aspect, or the first possible implementation manner of the third aspect, or the second possible implementation manner of the third aspect, or the third possible implementation manner of the third aspect, or the fourth possible implementation manner of the third aspect, in a fifth possible implementation manner of the third aspect, by invoking, by using the bus, the code stored in the memory, the processor is further configured to: after allocating the first address identifier recorded in the first valid address allocation record to the first user terminal indicated by the first user terminal identifier, determine a second routing rule corresponding to the first address identifier and the first user plane access node; and notify the first user plane access node of the second routing rule.

With reference to the third aspect, or the first possible implementation manner of the third aspect, or the second possible implementation manner of the third aspect, or the third possible implementation manner of the third aspect, or the fourth possible implementation manner of the third aspect, or the fifth possible implementation manner of the third aspect, in a sixth possible implementation manner of the third aspect, by invoking, by using the bus, the code stored in the memory, the processor is further configured to: after sending, to the first user plane access node, the first request response message in response to the first service request message, receive a second service request message that is from a second user plane access node and that carries the first user terminal identifier, where the second service request message is an access request message or a handover request message, and the second user plane access node and the first user plane access node belong to networks of different standards;

if the first valid address allocation record that matches the first user terminal identifier is found in the stored valid address allocation record, allocate the first address identifier recorded in the first valid address allocation record to the first user terminal; and

send, to the second user plane access node, a second request response message in response to the second service request message, where the second request response message carries the first address identifier, so that the second user plane access node notifies the first user terminal of the first address identifier.

With reference to the third aspect, or the first possible implementation manner of the third aspect, or the second possible implementation manner of the third aspect, or the third possible implementation manner of the third aspect, or the fourth possible implementation manner of the third aspect, or the fifth possible implementation manner of the third aspect, or the sixth possible implementation manner of the third aspect, in a seventh possible implementation manner of the third aspect,

by invoking, by using the bus, the code stored in the memory, the processor is further configured to: if no valid address allocation record that matches the first user terminal identifier is found in the stored valid address allocation record, allocate a second address identifier to the first user terminal, and send, to the first user plane access node, a second request response message in response to the first service request message, where the second request response message carries the second address identifier, so that the first user plane access node notifies the first user terminal of the second address identifier.

With reference to the seventh possible implementation manner of the third aspect, in an eighth possible implementation manner of the third aspect, by invoking, by using the bus, the code stored in the memory, the processor is further configured to: generate a second valid address allocation record according to the first user terminal identifier and the second address identifier, and store the second valid address allocation record, where the second valid address allocation record records the first user terminal identifier, the second address identifier, and a user plane access node identifier corresponding to the first user plane access node, or the second valid address allocation record records the first user terminal identifier and the second address identifier.

With reference to the seventh possible implementation manner of the third aspect or the eighth possible implementation manner of the third aspect, in a ninth possible implementation manner of the third aspect, by invoking, by using the bus, the code stored in the memory, the processor is further configured to: after allocating the second address identifier to the first user terminal, determine a third routing rule corresponding to the second address identifier and the gateway router; and notify the gateway router of the third routing rule.

With reference to the ninth possible implementation manner of the third aspect, in a tenth possible implementation manner of the third aspect,

by invoking, by using the bus, the code stored in the memory, the processor is further configured to: after allocating the second address identifier to the first user terminal, determine N2 routing rules corresponding to the second address identifier and the N2 OpenFlow switches, and send the N2 routing rules to the N2 OpenFlow switches, where a routing rule sent to each OpenFlow switch of the N2 OpenFlow switches is a routing rule in the N2 routing rules that is in a one-to-one correspondence with each OpenFlow switch, the N2 OpenFlow switches are the OpenFlow switches located on the transmission path between the gateway router and the first user plane access node, and N2 is a positive integer.

With reference to the seventh possible implementation manner of the third aspect, or the eighth possible implementation manner of the third aspect, or the ninth possible implementation manner of the third aspect, or the tenth possible implementation manner of the third aspect, in an eleventh possible implementation manner of the third aspect, by invoking, by using the bus, the code stored in the memory, the processor is further configured to: after allocating the second address identifier to the first user terminal, determine a fourth routing rule corresponding to the second address identifier and the first user plane access node; and notify the first user plane access node of the fourth routing rule.

With reference to the seventh possible implementation manner of the third aspect, or the eighth possible implementation manner of the third aspect, or the ninth possible implementation manner of the third aspect, or the tenth possible implementation manner of the third aspect, or the eleventh possible implementation manner of the third aspect, in a twelfth possible implementation manner of the third aspect, by invoking, by using the bus, the code stored in the memory, the processor is further configured to: after sending, to the first user plane access node, the second request response message in response to the first service request message, receive a second service request message that is from a third user plane access node and that carries the first user terminal identifier, where the second service request message is an access request message or a handover request message, and the third user plane access node and the first user plane access node belong to networks of a same standard or different standards;

if the second valid address allocation record that matches the first user terminal identifier is found in the stored valid address allocation record, allocate the second address identifier recorded in the second valid address allocation record to the first user terminal; and

send, to the third user plane access node, a third request response message in response to the second service request message, where the third request response message carries the second address identifier, so that the third user plane access node notifies the first user terminal of the second address identifier.

With reference to the seventh possible implementation manner of the third aspect, or the eighth possible implementation manner of the third aspect, or the ninth possible implementation manner of the third aspect, or the tenth possible implementation manner of the third aspect, or the eleventh possible implementation manner of the third aspect, or the twelfth possible implementation manner of the third aspect, in a thirteenth possible implementation manner of the third aspect, the second address identifier includes at least one of the following address identifiers: an Internet Protocol address, a Media Access Control address, and a network-wide unique user name.

With reference to the third aspect, or the first possible implementation manner of the third aspect, or the second possible implementation manner of the third aspect, or the third possible implementation manner of the third aspect, or the fourth possible implementation manner of the third aspect, or the fifth possible implementation manner of the third aspect, or the sixth possible implementation manner of the third aspect, or the seventh possible implementation manner of the third aspect, or the eighth possible implementation manner of the third aspect, or the ninth possible implementation manner of the third aspect, or the tenth possible implementation manner of the third aspect, or the eleventh possible implementation manner of the third aspect, or the twelfth possible implementation manner of the third aspect, or the thirteenth possible implementation manner of the third aspect, in a fourteenth possible implementation manner of the third aspect, the first address identifier includes at least one of the following address identifiers: an Internet Protocol address, a Media Access Control address, and a network-wide unique user name.

A fourth aspect of the present invention provides a control plane node, which may include:

a receiver, configured to receive a first service request message that is from a first user plane access node and that carries a first user terminal identifier, where the first service request message is an access request message or a handover request message;

a processor, configured to: search a stored valid address allocation record for a valid address allocation record that matches the first user terminal identifier, and if a first valid address allocation record that matches the first user terminal identifier is found in the stored valid address allocation record, allocate a first address identifier recorded in the first valid address allocation record to a first user terminal indicated by the first user terminal identifier; and

a transmitter, configured to send, to the first user plane access node, a first request response message in response to the first service request message, where the first request response message carries the first address identifier, so that the first user plane access node notifies the first user terminal of the first address identifier.

With reference to the fourth aspect, in a first possible implementation manner of the fourth aspect, the first valid address allocation record further records a user plane access node identifier, where a user plane access node indicated by the user plane access node identifier and the first user plane access node belong to networks of a same standard, or a user plane access node indicated by the user plane access node identifier and the first user plane access node belong to networks of different standards.

With reference to the fourth aspect or the first possible implementation manner of the fourth aspect, in a second possible implementation manner of the fourth aspect,

the processor is further configured to: after allocating the first address identifier recorded in the first valid address allocation record to the first user terminal indicated by the first user terminal identifier, determine a first routing rule corresponding to the first address identifier and a gateway router, and notify the gateway router of the first routing rule.

With reference to the second possible implementation manner of the fourth aspect, in a third possible implementation manner of the fourth aspect, the processor is further configured to: after allocating the first address identifier recorded in the first valid address allocation record to the first user terminal indicated by the first user terminal identifier, determine N1 routing rules corresponding to the first address identifier and N1 OpenFlow switches, and send the N1 routing rules to the N1 OpenFlow switches, where a routing rule sent to each OpenFlow switch of the N1 OpenFlow switches is a routing rule in the N1 routing rules that is in a one-to-one correspondence with each OpenFlow switch, the N1 OpenFlow switches are OpenFlow switches located on a transmission path between the gateway router and the first user plane access node, and N1 is a positive integer.

With reference to the fourth aspect, or the first possible implementation manner of the fourth aspect, or the second possible implementation manner of the fourth aspect, or the third possible implementation manner of the fourth aspect, in a fourth possible implementation manner of the fourth aspect, the processor is further configured to: after allocating the first address identifier recorded in the first valid address allocation record to the first user terminal indicated by the first user terminal identifier, determine a second routing rule corresponding to the first address identifier and the first user plane access node, and notify the first user plane access node of the second routing rule.

With reference to the fourth aspect, or the first possible implementation manner of the fourth aspect, or the second possible implementation manner of the fourth aspect, or the third possible implementation manner of the fourth aspect, or the fourth possible implementation manner of the fourth aspect, in a fifth possible implementation manner of the fourth aspect,

the receiver is further configured to: after the transmitter sends, to the first user plane access node, the first request response message in response to the first service request message, receive a second service request message that is from a second user plane access node and that carries the first user terminal identifier, where the second service request message is an access request message or a handover request message, and the second user plane access node and the first user plane access node belong to networks of different standards;

the processor is further configured to: if the first valid address allocation record that matches the first user terminal identifier is found in the stored valid address allocation record, allocate the first address identifier recorded in the first valid address allocation record to the first user terminal; and

the transmitter is further configured to send, to the second user plane access node, a second request response message in response to the second service request message, where the second request response message carries the first address identifier, so that the second user plane access node notifies the first user terminal of the first address identifier.

With reference to the fourth aspect, or the first possible implementation manner of the fourth aspect, or the second possible implementation manner of the fourth aspect, or the third possible implementation manner of the fourth aspect, or the fourth possible implementation manner of the fourth aspect, or the fifth possible implementation manner of the fourth aspect, in a sixth possible implementation manner of the fourth aspect,

the processor is further configured to: if no valid address allocation record that matches the first user terminal identifier is found in the stored valid address allocation record, allocate a second address identifier to the first user terminal; and

the transmitter is further configured to send, to the first user plane access node, a second request response message in response to the first service request message, where the second request response message carries the second address identifier, so that the first user plane access node notifies the first user terminal of the second address identifier.

With reference to the sixth possible implementation manner of the fourth aspect, in a seventh possible implementation manner of the fourth aspect,

the processor is further configured to: generate a second valid address allocation record according to the first user terminal identifier and the first address identifier, and store the second valid address allocation record, where the second valid address allocation record records the first user terminal identifier, the first address identifier, and a user plane access node identifier corresponding to the first user plane access node, or the second valid address allocation record records the first user terminal identifier and the first address identifier.

With reference to the fifth possible implementation manner of the fourth aspect, or the sixth possible implementation manner of the fourth aspect, or the seventh possible implementation manner of the fourth aspect, in an eighth possible implementation manner of the fourth aspect, the processor is further configured to: after allocating the second address identifier to the first user terminal, determine a third routing rule corresponding to the second address identifier and the gateway router, and notify the gateway router of the third routing rule.

With reference to the eighth possible implementation manner of the fourth aspect, in a ninth possible implementation manner of the fourth aspect, the processor is further configured to: after allocating the second address identifier to the first user terminal, determine N2 routing rules corresponding to the second address identifier and the N2 OpenFlow switches, and send the N2 routing rules to the N2 OpenFlow switches, where a routing rule sent to each OpenFlow switch of the N2 OpenFlow switches is a routing rule in the N2 routing rules that is in a one-to-one correspondence with each OpenFlow switch, the N2 OpenFlow switches are the OpenFlow switches located on the transmission path between the gateway router and the first user plane access node, and N2 is a positive integer.

With reference to the sixth possible implementation manner of the fourth aspect, or the seventh possible implementation manner of the fourth aspect, or the eighth possible implementation manner of the fourth aspect, or the ninth possible implementation manner of the fourth aspect, in a tenth possible implementation manner of the fourth aspect, the processor is further configured to: after allocating the second address identifier to the first user terminal, determine a fourth routing rule corresponding to the second address identifier and the first user plane access node, and notify the first user plane access node of the fourth routing rule.

With reference to the sixth possible implementation manner of the fourth aspect, or the seventh possible implementation manner of the fourth aspect, or the eighth possible implementation manner of the fourth aspect, or the ninth possible implementation manner of the fourth aspect, or the tenth possible implementation manner of the fourth aspect, in an eleventh possible implementation manner of the fourth aspect,

the receiver is further configured to: after the transmitter sends, to the first user plane access node, the second request response message in response to the first service request message, receive a second service request message that is from a third user plane access node and that carries the first user terminal identifier, where the second service request message is an access request message or a handover request message, and the third user plane access node and the first user plane access node belong to networks of a same standard or different standards;

the processor is further configured to: if the second valid address allocation record that matches the first user terminal identifier is found in the stored valid address allocation record, allocate the second address identifier recorded in the second valid address allocation record to the first user terminal; and

the transmitter is further configured to send, to the third user plane access node, a third request response message in response to the second service request message, where the third request response message carries the second address identifier, so that the third user plane access node notifies the first user terminal of the second address identifier.

With reference to the sixth possible implementation manner of the fourth aspect, or the seventh possible implementation manner of the fourth aspect, or the eighth possible implementation manner of the fourth aspect, or the ninth possible implementation manner of the fourth aspect, or the tenth possible implementation manner of the fourth aspect, or the eleventh possible implementation manner of the fourth aspect, in a twelfth possible implementation manner of the fourth aspect, the second address identifier includes at least one of the following address identifiers: an Internet Protocol address, a Media Access Control address, and a network-wide unique user name.

With reference to the fourth aspect, or the first possible implementation manner of the fourth aspect, or the second possible implementation manner of the fourth aspect, or the third possible implementation manner of the fourth aspect, or the fourth possible implementation manner of the fourth aspect, or the fifth possible implementation manner of the fourth aspect, or the sixth possible implementation manner of the fourth aspect, or the seventh possible implementation manner of the fourth aspect, or the eighth possible implementation manner of the fourth aspect, or the ninth possible implementation manner of the fourth aspect, or the tenth possible implementation manner of the fourth aspect, or the eleventh possible implementation manner of the fourth aspect, or the twelfth possible implementation manner of the fourth aspect, in a thirteenth possible implementation manner of the fourth aspect, the first address identifier includes at least one of the following address identifiers: an Internet Protocol address, a Media Access Control address, and a network-wide unique user name.

A fifth aspect of the present invention further provides a communications system, which may include a control plane node and at least one user plane access node including a first user plane access node, where the control plane node is any control plane node provided in the present invention.

A sixth aspect of the present invention further provides a computer storage medium, where the computer storage medium may store a program, and when the program is executed, some or all steps of any address identifier allocation method provided in the present invention are executed.

It can be learned that, in the solutions of the present invention, a unified control plane node is introduced into a network, and whether in an initial access process of a user terminal or in a network handover process of a user terminal, allocation and management of an address identifier of the user terminal are completed by the unified control plane node, which changes a mode in the prior art in which address identifiers of a user terminal that are corresponding to different networks are respectively managed in the networks, helps simplify complexity of address management of a user terminal, and improves unified controllability.

### BRIEF DESCRIPTION OF THE DRAWINGS

To describe the technical solutions in the embodiments of the present invention more clearly, the following briefly introduces the accompanying drawings required for describing the embodiments. Apparently, the accompanying drawings in the following description show merely some embodiments of the present invention, and persons of ordinary skill in the art may still derive other drawings from these accompanying drawings without creative efforts.

FIG. 1-a is a schematic diagram of a network architecture according to an embodiment of the present invention;

FIG. 1-b is a schematic flowchart of an address identifier allocation method according to an embodiment of the present invention;

FIG. 2 is a schematic flowchart of another address identifier allocation method according to an embodiment of the present invention;

FIG. 3 is a schematic flowchart of another address identifier allocation method according to an embodiment of the present invention;

FIG. 4A and FIG. 4B are a schematic flowchart of another address identifier allocation method according to an embodiment of the present invention;

FIG. 5-a is a schematic diagram of a control plane node according to an embodiment of the present invention;

FIG. 5-b is a schematic diagram of another control plane node according to an embodiment of the present invention;

FIG. 5-c is a schematic diagram of another control plane node according to an embodiment of the present invention;

FIG. 5-d is a schematic diagram of another control plane node according to an embodiment of the present invention;

FIG. 6 is a schematic diagram of another control plane node according to an embodiment of the present invention;

FIG. 7 is a schematic diagram of another control plane node according to an embodiment of the present invention;

FIG. 8 is a schematic diagram of another control plane node according to an embodiment of the present invention; and

FIG. 9 is a schematic diagram of a communications system according to an embodiment of the present invention.

### DETAILED DESCRIPTION

Embodiments of the present invention provide an address identifier allocation method, a related device, and a system, to reduce complexity of allocation and management of an address identifier of a user terminal.

To make the present invention objectives, features, and advantages of the present invention clearer and more comprehensible, the following clearly describes the technical solutions in the embodiments of the present invention with reference to the accompanying drawings in the embodiments of the present invention. Apparently, the embodiments described in the following are merely some but not all of the embodiments of the present invention. All other embodiments obtained by persons of ordinary skill in the art based on the embodiments of the present invention without creative efforts shall fall within the protection scope of the present invention.

Detailed descriptions are hereinafter provided separately by using specific embodiments.

In the specification, claims, and accompanying drawings of the present invention, the terms “first”, “second”, “third”, “fourth”, and so on are intended to distinguish between different objects but are not intended to describe a specific order. In addition, the terms “include”, “have”, and their variations are intended to cover nonexclusive including. For example, a process, a method, a system, a product, or a device that includes a series of steps or units is not limited to the listed steps or units, but optionally further includes an unlisted step or unit, or optionally further includes another inherent step or unit of the process, the method, the product, or the device.

The following briefly describes an OpenFlow mechanism.

An OpenFlow (OpenFlow) technology is first put forward in Stanford University and aims to resolve, based on a Transmission Control Protocol/Internet Protocol (TCP/IP, Transmission Control Protocol/Internet Protocol) technical condition and by using an innovative network interconnection idea, various bottleneck problems occurring in front of a new service in a current network. A core idea of the OpenFlow technology is to change a data packet forwarding process that is originally controlled totally by a switch/router to independent processes separately completed by an OpenFlow switch (OpenFlow Switch) and a software-defined networking (SDN, Software Defined Network) controller (Controller).

In an SDN architecture, an SDN controller determines paths on which all packets are transmitted in a network. An OpenFlow switch locally maintains several flow tables (Flow Table) different from a forwarding information table. If a packet that needs to be forwarded has a matched flow entry in the flow table, forwarding processing is performed based on the corresponding flow entry in the Flow Table. If the Flow Table does not have a corresponding flow entry of the packet, the packet is sent to a controller to confirm a transmission path, the controller transmits a new flow entry to an OpenFlow switch device, and the OpenFlow switch device forwards the packet according to the delivered new flow entry. This means that a device in an OpenFlow network can perform distribution and deployment, and centralized management and control, to change the network into a software-definable form. OpenFlow provides a programmable interface, so that a network user can determine how to route a packet, how to implement load balance, how to perform access control, or the like. Therefore, deploying a new routing protocol or security algorithm in a network generally only needs to write hundreds of lines of code on an SDN controller, openness of which helps accelerate rapid development and deployment of a new network application.

SDN implements, based on a general IT-ization platform, separation of a control plane and a data plane that are of a functional network element (which is mainly a switch, a router, or the like) in a network, and opens interfaces of the control plane and the data plane. A user may define a logical network topology by using software, to meet different requirements for network resources without considering a physical topology structure of an underlying network.

A heterogeneous access network convergence solution includes a physical layer (L1) convergence solution, a data link layer (L2) convergence solution, a network layer (L3) convergence solution, and the like. Convergence solutions at different layers bring different beneficial effects and are for different scenarios. At present, in a heterogeneous access network convergence scenario, in the prior art, an address identifier (for example, an IP address) of a user terminal is generally independently managed in each subnet. The present invention can resolve an IP address problem in a network layer (L3) convergence solution in a wireless network SDN architecture scenario, for example, IP address management during handover of a user terminal between heterogeneous access networks. Certainly, the following address management solution may also be used when a user terminal performs re-access between different access nodes in networks of a same standard.

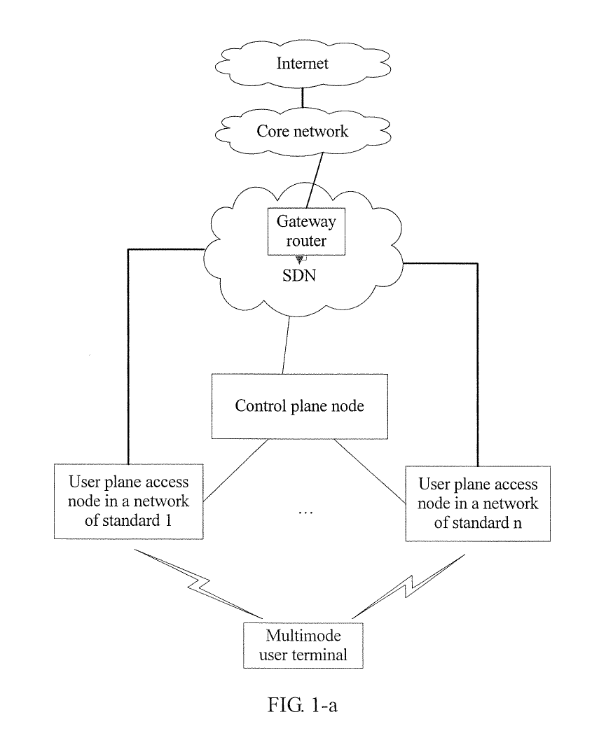

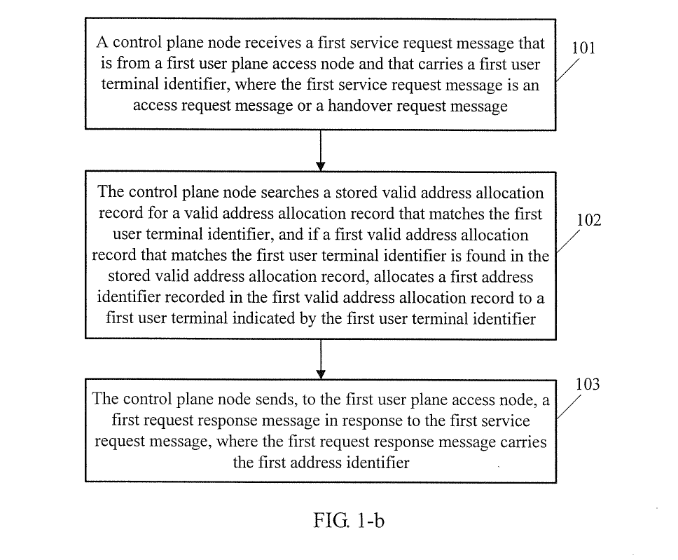

Referring to FIG. 1-a, FIG. 1-a is a diagram of a communications network architecture according to an embodiment of the present invention. A communications network includes a control plane node and several user plane access nodes. A user terminal may access a network by using the user plane access node, the control plane node may perform control plane management on each user plane access node, and the control plane node may further configure routing rules (in this case, the control plane node has a function of an SDN controller) for a gateway router and each OpenFlow switch (if there is an OpenFlow switch) in SDN.

The technical solution in this embodiment of the present invention may be applied, for example, to a “cellular+WiFi (or wireless local area network (WLAN, Wireless Local Area Network))” heterogeneous access network convergence scenario, and certainly, may also be applied to a scenario of heterogeneous access network convergence between two or more cellular networks of different standards. Certainly, the technical solution may also be applied to another heterogeneous access network convergence scenario. For example, user plane access nodes, used as an example in FIG. 1-a, of several network standards may include, a user plane access node (which may include user plane access nodes in cellular networks of several different standards) in a cellular network, a user plane access node in a WiFi network (or a WLAN network), and a user plane access node in a sensor network, and certainly, may further include a user plane access node in a network of another standard. Certainly, the solution in this embodiment of the present invention may also be applied to allocation and management of an address identifier in networks of a same standard. The solution in this embodiment of the present invention may be specifically implemented based on the communications network architecture shown in FIG. 1-a, and certainly, may also be specifically implemented based on a variation architecture of the communications network architecture shown in FIG. 1-a.

In an actual network, a control plane node may have multiple product forms, for example, a control plane node may be a wireless network controller or an access point controller (AC, Access point controller). A user plane access node is an access network element having a user terminal radio access capability. Certainly, a user plane access node may also have multiple product forms, for example, a user plane access node may be an access node (AP, Access point), an evolved NodeB (eNodeB, Evolved NodeB), or a base station of another type. The control plane node in the embodiments of the present invention may have a function of an SDN controller.

In an embodiment of an address identifier allocation method of the present invention, the address identifier allocation method may include: receiving, by a control plane node, a first service request message that is from a first user plane access node and that carries a first user terminal identifier, where the first service request message is an access request message or a handover request message; searching, by the control plane node, a stored valid address allocation record for a valid address allocation record that matches the first user terminal identifier; if a first valid address allocation record that matches the first user terminal identifier is found in the stored valid address allocation record, allocating a first address identifier recorded in the first valid address allocation record to a first user terminal indicated by the first user terminal identifier; and sending, to the first user plane access node by the control plane node, a first request response message in response to the first service request message, where the first request response message carries the first address identifier, so that the first user plane access node notifies the first user terminal of the first address identifier.

Referring to FIG. 1-b, FIG. 1-b is a schematic flowchart of an address identifier allocation method according to an embodiment of the present invention. As shown in FIG. 1-b, the address identifier allocation method according to this embodiment of the present invention may include the following content:

101. A control plane node receives a first service request message that is from a first user plane access node and that carries a first user terminal identifier, where the first service request message is an access request message or a handover request message.

102. The control plane node searches a stored valid address allocation record for a valid address allocation record that matches the first user terminal identifier, and if a first valid address allocation record that matches the first user terminal identifier is found in the stored valid address allocation record, allocates a first address identifier recorded in the first valid address allocation record to a first user terminal indicated by the first user terminal identifier.

In some embodiments of the present invention, the control plane node may locally store one or more valid address allocation records. The one or more valid address allocation records locally stored in the control plane node may be preconfigured in the control plane node; certainly, the one or more valid address allocation records locally stored in the control plane node may also be generated by the control plane node according to a previous network access or handover status of a user terminal. Further, the control plane node may update the one or more locally stored valid address allocation records. Certainly, a third-party device may also store one or more valid address allocation records, and the control plane node may search the one or more valid address allocation records stored in the third-party device for a valid address allocation record that matches the first user terminal identifier. Further, the third-party device may update the one or more valid address allocation records stored in the third-party device.

In some embodiments of the present invention, the first user terminal is a multimode user terminal, and certainly, the first user terminal may also be a single-mode user terminal.

103. The control plane node sends, to the first user plane access node, a first request response message in response to the first service request message, where the first request response message carries the first address identifier, so that the first user plane access node notifies the first user terminal of the first address identifier.

In some embodiments of the present invention, each valid address allocation record of the stored valid address allocation record may further record a user plane access node identifier. For example, the first valid address allocation record further records a user plane access node identifier, where a user plane access node indicated by the user plane access node identifier and the first user plane access node are corresponding to a same network standard or different network standards.

In some embodiments of the present invention, the first valid address allocation record further records a user plane access node identifier, where a user plane access node indicated by the user plane access node identifier and the first user plane access node belong to networks of a same standard. For example, standards of both a network to which the user plane access node indicated by the user plane access node identifier belongs and a network to which the first user plane access node belongs are cellular networks (for example, Long Term Evolution (LTE, Long Term Evolution) networks) or WiFi networks. Alternatively, a user plane access node indicated by the user plane access node identifier and the first user plane access node belong to networks of different standards. For example, a standard of a network to which the user plane access node indicated by the user plane access node identifier belongs is a cellular network (for example, an LTE network), and a standard of a network to which the first user plane access node belongs is WiFi; or a standard of a network to which the user plane access node indicated by the user plane access node identifier belongs is WiFi, and a standard of a network to which the first user plane access node belongs is a cellular network (for example, an LTE network).

In some embodiments of the present invention, the first user terminal may be a multimode user terminal.

In some embodiments of the present invention, after the allocating a first address identifier recorded in the first valid address allocation record to a first user terminal indicated by the first user terminal identifier, the address identifier allocation method may further include: determining, by the control plane node, a first routing rule corresponding to the first address identifier and a gateway router; and notifying, by the control plane node, the gateway router of the first routing rule.

In some embodiments of the present invention, after the allocating a first address identifier recorded in the first valid address allocation record to a first user terminal indicated by the first user terminal identifier, the address identifier allocation method may further include: determining, by the control plane node, N1 routing rules corresponding to the first address identifier and N1 OpenFlow switches; and sending, by the control plane node, the N1 routing rules to the N1 OpenFlow switches, where a routing rule sent to each OpenFlow switch of the N1 OpenFlow switches is a routing rule in the N1 routing rules that is in a one-to-one correspondence with each OpenFlow switch, the N1 OpenFlow switches are OpenFlow switches located on a transmission path between the gateway router and the first user plane access node, and N1 is a positive integer.

In some embodiments of the present invention, after the allocating a first address identifier recorded in the first valid address allocation record to a first user terminal indicated by the first user terminal identifier, the address identifier allocation method further includes: determining, by the control plane node, a second routing rule corresponding to the first address identifier and the first user plane access node; and notifying, by the control plane node, the first user plane access node of the second routing rule.

In some embodiments of the present invention, after the sending, to the first user plane access node by the control plane node, a first request response message in response to the first service request message, the address identifier allocation method may further include:

receiving, by the control plane node, a second service request message that is from a second user plane access node and that carries the first user terminal identifier, where the second service request message is an access request message or a handover request message, and the second user plane access node and the first user plane access node belong to networks of different standards;

if the first valid address allocation record that matches the first user terminal identifier is found in the stored valid address allocation record (the stored valid address allocation record includes the first valid address allocation record), allocating, by the control plane node, the first address identifier recorded in the first valid address allocation record to the first user terminal; and

sending, to the second user plane access node by the control plane node, a second request response message in response to the second service request message, where the second request response message carries the first address identifier, so that the second user plane access node notifies the first user terminal of the first address identifier.

In some embodiments of the present invention, the first address identifier may include at least one of the following address identifiers: an Internet Protocol address, a Media Access Control address, and/or a network-wide unique user name (the user name may be a character string, a digit string, or another user name that is network-wide unique).

In some embodiments of the present invention, the address identifier allocation method may further include:

if no valid address allocation record that matches the first user terminal identifier is found in the stored valid address allocation record, allocating, by the control plane node, a second address identifier to the first user terminal, and sending, to the first user plane access node by the control plane node, a second request response message in response to the first service request message, where the second request response message carries the second address identifier, so that the first user plane access node notifies the first user terminal of the second address identifier.

In some embodiments of the present invention, the address identifier allocation method may further include: generating a second valid address allocation record according to the first user terminal identifier and the second address identifier, and storing the second valid address allocation record, where the second valid address allocation record records the first user terminal identifier and the second address identifier, or the second valid address allocation record records the first user terminal identifier, the second address identifier, and a user plane access node identifier corresponding to the first user plane access node.

In some embodiments of the present invention, after the allocating, by the control plane node, a second address identifier to the first user terminal, the address identifier allocation method may further include: determining, by the control plane node, a third routing rule corresponding to the second address identifier and the gateway router; and notifying, by the control plane node, the gateway router of the third routing rule.

In some embodiments of the present invention, after the allocating, by the control plane node, a second address identifier to the first user terminal, the address identifier allocation method may further include: determining, by the control plane node, N2 routing rules corresponding to the second address identifier and the N2 OpenFlow switches; and sending, by the control plane node, the N2 routing rules to the N2 OpenFlow switches, where a routing rule sent to each OpenFlow switch of the N2 OpenFlow switches is a routing rule in the N2 routing rules that is in a one-to-one correspondence with each OpenFlow switch, the N2 OpenFlow switches are the OpenFlow switches located on the transmission path between the gateway router and the first user plane access node, and N2 is a positive integer.

In some embodiments of the present invention, after the allocating, by the control plane node, a second address identifier to the first user terminal, the address identifier allocation method may further include: determining, by the control plane node, a fourth routing rule corresponding to the second address identifier and the first user plane access node; and notifying, by the control plane node, the first user plane access node of the fourth routing rule.

In some embodiments of the present invention, after the sending, to the first user plane access node by the control plane node, a second request response message in response to the first service request message, the address identifier allocation method may further include:

receiving, by the control plane node, a second service request message that is from a third user plane access node and that carries the first user terminal identifier, where the second service request message is an access request message or a handover request message, and the third user plane access node and the first user plane access node belong to networks of a same standard or different standards;

if the second valid address allocation record that matches the first user terminal identifier is found in the stored valid address allocation record, allocating, by the control plane node, the second address identifier recorded in the second valid address allocation record to the first user terminal; and

sending, to the third user plane access node by the control plane node, a third request response message in response to the second service request message, where the third request response message carries the second address identifier, so that the third user plane access node notifies the first user terminal of the second address identifier.

In some embodiments of the present invention, the second address identifier is an Internet Protocol address, a Media Access Control address, and/or a network-wide unique user name (the user name may be a character string, a digit string, or another user name that is network-wide unique).

In some embodiments of the present invention, the control plane node may further configure an aging time for a valid address allocation record, and the control plane node may delete a valid address allocation record whose aging time expires, or may mark a valid address allocation record whose aging time expires as an invalid address allocation record.

It may be understood that the first user plane access node (or the second user plane access node or the third user plane access node), the gateway router, and the N1 OpenFlow switches (or the N2 OpenFlow switches) may perform, based on a routing rule corresponding to the first address identifier (or the second address identifier), routing control on a received data packet whose source address or destination address is the first address identifier (or the second address identifier).

It can be learned that, in this embodiment, a unified control plane node is introduced into a network, and whether in an initial access process of a user terminal or in a network handover process of a user terminal, allocation and management of an address identifier of the user terminal are completed by the unified control plane node, which changes a mode in the prior art in which address identifiers of a user terminal that are corresponding to different networks are respectively managed in the networks. In addition, the control plane node searches a stored valid address allocation record for a valid address allocation record that matches a first user terminal identifier; and if a first valid address allocation record that matches the first user terminal identifier is found in the stored valid address allocation record, allocates a first address identifier recorded in the first valid address allocation record to a first user terminal indicated by the first user terminal identifier. It can be learned that using the unified control plane node helps ensure that a user terminal uses a same address identifier (for example, an IP address) as possible when being handed over to a different network or accessing a same network by using different user plane access nodes of a same network, and using a same address identifier in these scenarios helps significantly simplify complexity of management of cross-network or cross-access node communication of user data, and further helps simplify a routing rule of a user data packet.

To help better understand and implement the solution of this embodiment of the present invention, the following uses some specific examples for description.

A process in which a user terminal performs initial access (initial access may relate to network authentication, registration, and the like of a user terminal) relates to the address identifier allocation method in the embodiment of the present invention. In an example of this embodiment, a base station access point (for example, a C-uNB or a W-uNB) is used as a user plane access node, and a Single-cNB is used as a control plane node.

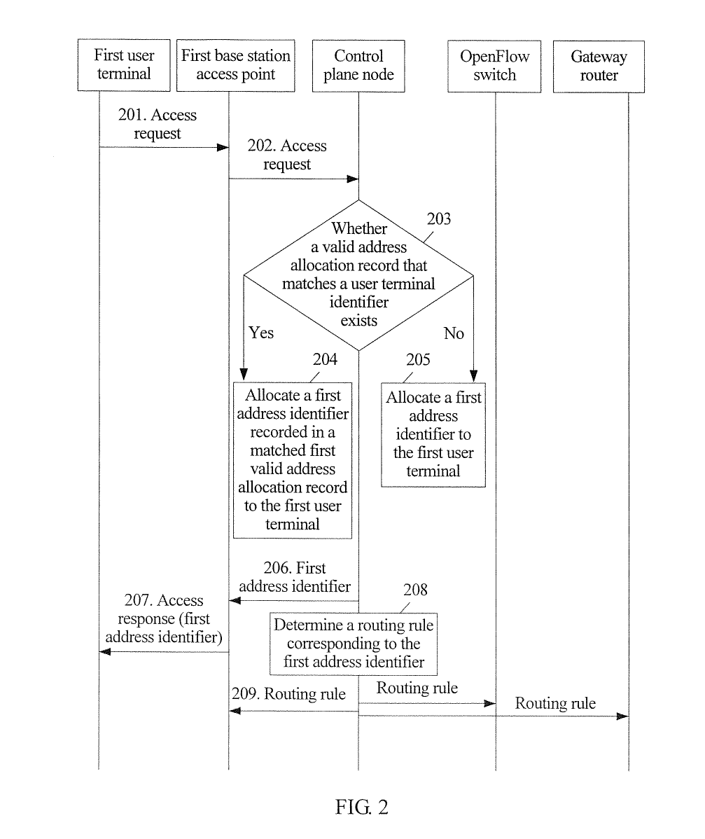

Referring to FIG. 2, FIG. 2 is a schematic flowchart of an address identifier allocation method according to another embodiment of the present invention. As shown in FIG. 2, the address identifier allocation method according to the another embodiment of the present invention may include the following content:

201. A first user terminal sends an access request s1 to a first base station access point, where the access request s1 carries a first user terminal identifier.

In an example of this embodiment, the first user terminal is mainly a multimode user terminal.

202. The first base station access point reports the access request s1 to a Single-cNB.

203. The Single-cNB searches a stored valid address allocation record to determine whether a valid address allocation record that matches the first user terminal identifier exists.

If yes (that is, the Single-cNB finds, in the stored valid address allocation record, a first valid address allocation record that matches the first user terminal identifier), step 204 is executed.

If no (that is, the Single-cNB does not find, in the stored valid address allocation record, any valid address allocation record that matches the first user terminal identifier), step 205 is executed.

204. The Single-cNB may allocate a first address identifier recorded in the first valid address allocation record to the first user terminal; and skip to step 206.

In some embodiments of the present invention, the first valid address allocation record further records a base station access point identifier, where a second base station access point indicated by the base station access point identifier and the first base station access point belong to networks of different standards. For example, the second base station access point is a base station access point in a cellular network, and the first base station access point is a base station access point in a WiFi network; or the first base station access point may be a base station access point in a cellular network, and the second base station access point may be a base station access point in a WiFi network.

Certainly, the second base station access point and the first base station access point may also belong to networks of a same standard.

205. The Single-cNB allocates the first address identifier to the first user terminal; and the Single-cNB generates a second valid address allocation record according to the first user terminal identifier and the first address identifier, and stores the second valid address allocation record.

The second valid address allocation record records the first user terminal identifier, the first address identifier, and a base station access point identifier corresponding to the first base station access point; or the second valid address allocation record records the first user terminal identifier and the first address identifier.

206. The Single-cNB may send, to the first base station access point, an access response s2 in response to the access request s1, where the access response s2 may carry the first address identifier allocated by the Single-cNB to the first user terminal.

207. The first base station access point forwards the access response s2 to the first user terminal.

208. The Single-cNB determines, based on a preset policy, a routing rule corresponding to the first address identifier.

It may be understood that the routing rule corresponding to the first address identifier is mainly used to perform routing control on a data packet whose source address or destination address is the first address identifier.

The Single-cNB may determine, based on the preset policy, a routing rule r1 corresponding to the first address identifier and the first base station access point, and the Single-cNB may determine, based on the preset policy, a routing rule r2 corresponding to the first address identifier and a gateway router. The Single-cNB determines N1 routing rules corresponding to the first address identifier and N1 OpenFlow switches, where the N1 OpenFlow switches are in a one-to-one correspondence with the N1 routing rules.

The N1 OpenFlow switches are OpenFlow switches located on a transmission path between the gateway router and the first base station access point, where N1 is a positive integer.

209. The Single-cNB sends an OpenFlow protocol message m1 to a gateway router, where a flow entry carried in the OpenFlow protocol message m1 includes a routing rule r2; and the Single-cNB sends an OpenFlow protocol message m2 to the first base station access point, where a flow entry carried in the OpenFlow protocol message m2 includes a routing rule r1.

The Single-cNB sends an OpenFlow protocol message to each OpenFlow switch of the N1 OpenFlow switches, where a flow entry carried in the OpenFlow protocol message sent by the Single-cNB to each OpenFlow switch includes a routing rule, corresponding to each OpenFlow switch, in the N1 routing rules.

So far, when the first user terminal needs to communicate with an external network (for example, the Internet), the first user terminal communicates with the external network by using the first address identifier allocated by the Single-cNB to the first user terminal and by using a data path including the first base station access point, the gateway router, and the N1 OpenFlow switches. The data path herein includes two main parts: air-interface communication (between the first user terminal and the first base station access point) and IP communication (between the first base station access point and the gateway router) of a wired SDN mechanism. The first base station access point, the gateway router, and the N1 OpenFlow switches may perform, based on the routing rule corresponding to the first address identifier, routing control on the data packet whose source address or destination address is the first address identifier.

It may be understood that step 208 or step 209 and step 207 or step 206 may not necessarily be performed in order.

It may be understood in this embodiment that the Single-cNB determines a routing rule corresponding to the first address identifier and an OpenFlow switch is mainly used as an example for description. Certainly, the gateway router may also determine a routing rule corresponding to the first address identifier and an OpenFlow switch, and the gateway router may deliver, to the OpenFlow switch, an OpenFlow protocol message carrying the routing rule. Further, a current base station access point may send a new-path effect-taking notification to the Single-cNB after detecting that a path to the gateway router takes effect. The Single-cNB may further send an old-path routing rule to the gateway router, and the gateway router may delete a routing rule, corresponding to the first address identifier, of an OpenFlow switch on a path to an old base station access point.

It can be learned that, in this embodiment, a unified control plane node Single-cNB is introduced into a network, and in an initial access process of a user terminal, allocation and management of an address identifier of the user terminal are completed by the unified control plane node, which changes a mode in the prior art in which address identifiers of a user terminal that are corresponding to different networks are respectively managed in the networks.

In addition, the control plane node searches a stored valid address allocation record for a valid address allocation record that matches a first user terminal identifier; and if a first valid address allocation record that matches the first user terminal identifier is found in the stored valid address allocation record, allocates a first address identifier recorded in the first valid address allocation record to a first user terminal indicated by the first user terminal identifier. It can be learned that using the unified control plane node helps ensure that a user terminal uses a same address identifier (for example, an IP address) as possible when performing access by using different user plane access nodes of a same network, and using a same address identifier in this scenario helps significantly simplify complexity of management of cross-network or cross-access node communication of user data, and further helps simplify a routing rule of a user data packet.

The following uses an example to describe an address identifier allocation method in an embodiment of the present invention related to a process in which a user terminal is handed over between base station access points. In an example of this embodiment, a base station access point (for example, a first base station access point and a second base station access point) is used as a user plane access node, and a Single-cNB is used as a control plane node.

Referring to FIG. 3, FIG. 3 is a schematic flowchart of an address identifier allocation method according to another embodiment of the present invention. As shown in FIG. 3, the address identifier allocation method according to the another embodiment of the present invention may include the following content:

301. A first user terminal sends a handover request s3 to a first base station access point.

The handover request s3 carries a first user terminal identifier.

In an example of this embodiment, the first user terminal is mainly a multimode user terminal.

302. The first base station access point reports the handover request s3 to a Single-cNB.

In this embodiment of the present invention, a specific handover triggering reason or an initiator is not a focus, and may be one or more of multiple handover triggering mechanisms provided that a handover of a user terminal from an old base station access point (a second base station access point) to a new base station access point (the first base station access point) is triggered. For example, a used handover triggering mechanism may be that a user terminal periodically monitors quality of radio channels to the new base station access point and the old base station access point, handover is triggered when a quality difference between the two radio channels reaches a specific threshold, and then the user terminal may send the handover request s3 to the new base station access point (that is, the first base station access point).

In some cases, the new base station access point or the old base station access point may also actively initiate a procedure of handover of the user terminal from the old base station access point to the new base station access point. In this scenario, step 301 may be omitted.

If determining that the handover of the user terminal from the old base station access point to the new base station access point is permitted, the Single-cNB may allocate a radio resource of the new base station access point to the user terminal. In an example of this embodiment, the Single-cNB determines that the handover of the user terminal from the old base station access point to the new base station access point is permitted.

303. The Single-cNB searches a stored valid address allocation record to determine whether a valid address allocation record that matches the first user terminal identifier exists.

If yes (that is, the Single-cNB finds, in the stored valid address allocation record, a first valid address allocation record that matches the first user terminal identifier), step 304 is executed.

If no (that is, the Single-cNB does not find, in the stored valid address allocation record, any valid address allocation record that matches the first user terminal identifier), step 305 is executed.

304. The Single-cNB may allocate a first address identifier recorded in the first valid address allocation record to the first user terminal; and skip to step 306.

In some embodiments of the present invention, the first valid address allocation record further records a base station access point identifier (for example, a base station access point identifier corresponding to the second base station access point), where the second base station access point indicated by the base station access point identifier and the first base station access point belong to networks of different standards. For example, the second base station access point is a base station access point in a cellular network, and the first base station access point is a base station access point in a WiFi network; or the first base station access point is a base station access point in a cellular network, and the second base station access point is a base station access point in a WiFi network.

Further, if the first valid address allocation record further records the base station access point identifier corresponding to the second base station access point, the Single-cNB may further replace the base station access point identifier that is recorded in the first valid address allocation record and that is corresponding to the second base station access point with a base station access point identifier corresponding to the first base station access point.

305. The Single-cNB may allocate a first address identifier to the first user terminal, and the Single-cNB generates a second valid address allocation record based on the first user terminal identifier and the first address identifier, and stores the second valid address allocation record, where the second valid address allocation record records the first user terminal identifier and the first address identifier, or the second valid address allocation record records the first user terminal identifier, the first address identifier, and a base station access point identifier corresponding to the first base station access point.

306. The Single-cNB may send, to the first base station access point, a handover response s4 in response to the handover request s3, where the access response s4 may carry the first address identifier allocated to the first user terminal.

307. The first base station access point sends, to the first user terminal, the handover response s4 in response to the handover request s3.

308. The Single-cNB determines, based on a preset policy, a routing rule corresponding to the first address identifier.

It may be understood that the routing rule corresponding to the first address identifier is mainly used to perform routing control on a data packet whose source address or destination address is the first address identifier.

The Single-cNB may determine, based on the preset policy, a routing rule r1 corresponding to the first address identifier and the first base station access point, and the Single-cNB may determine, based on the preset policy, a routing rule r2 corresponding to the first address identifier and a gateway router. The Single-cNB determines N1 routing rules corresponding to the first address identifier and N1 OpenFlow switches, where the N1 OpenFlow switches are in a one-to-one correspondence with the N1 routing rules.

The N1 OpenFlow switches are OpenFlow switches located on a transmission path between the gateway router and a first user plane access node, where N1 is a positive integer.

309. The Single-cNB sends an OpenFlow protocol message m1 to a gateway router, where a flow entry carried in the OpenFlow protocol message m1 includes a routing rule r2; and the Single-cNB sends an OpenFlow protocol message m2 to the first base station access point, where a flow entry carried in the OpenFlow protocol message m2 includes a routing rule r1.

The Single-cNB sends an OpenFlow protocol message to each OpenFlow switch of the N1 OpenFlow switches, where a flow entry carried in the OpenFlow protocol message sent by the Single-cNB to each OpenFlow switch includes a routing rule, corresponding to each OpenFlow switch, in the N1 routing rules.

So far, when the first user terminal needs to communicate with an external network, the first user terminal communicates with the external network by using the first address identifier allocated by the Single-cNB to the first user terminal and by using a data path including the first base station access point, the gateway router, and the N1 OpenFlow switches. The data path herein includes two main parts: air-interface communication (between the first user terminal and the first base station access point) and IP communication (between the first base station access point and the gateway router) of a wired SDN mechanism.

The first base station access point, the gateway router, and the N1 OpenFlow switches may perform, based on the routing rule corresponding to the first address identifier, routing control on the data packet whose source address or destination address is the first address identifier.

It may be understood that step 308 or step 309 and step 307 or step 308 may not necessarily be performed in order.

It may be understood in this embodiment that the Single-cNB determines a routing rule corresponding to the first address identifier and an OpenFlow switch is mainly used as an example for description. Certainly, the gateway router may also determine a routing rule corresponding to the first address identifier and an OpenFlow switch, and the gateway router may deliver, to the OpenFlow switch, an OpenFlow protocol message carrying the routing rule. Further, a current base station access point may further send a new-path effect-taking notification to the Single-cNB after detecting that a path to the gateway router takes effect. The Single-cNB may further send an old-path routing rule to the gateway router, and the gateway router may delete a routing rule, corresponding to the first address identifier, of an OpenFlow switch on a path to the old base station access point.

It can be learned that, in this embodiment, a unified control plane node Single-cNB is introduced into a network, and in a network handover process of a user terminal, allocation and management of an address identifier of the user terminal are completed by the unified control plane node, which changes a mode in the prior art in which address identifiers of a user terminal that are corresponding to different networks are respectively managed in the networks. In addition, the control plane node searches a stored valid address allocation record for a valid address allocation record that matches the first user terminal identifier; and if a first valid address allocation record that matches the first user terminal identifier is found in the stored valid address allocation record, allocates a first address identifier recorded in the first valid address allocation record to a first user terminal indicated by the first user terminal identifier. It can be learned that using the unified control plane node helps ensure that a user terminal uses a same address identifier (for example, an IP address) as possible when being handed over to a different network, and using a same address identifier in these scenarios helps significantly simplify complexity of management of cross-network or cross-access node communication of user data, and further helps simplify a routing rule of a user data packet.

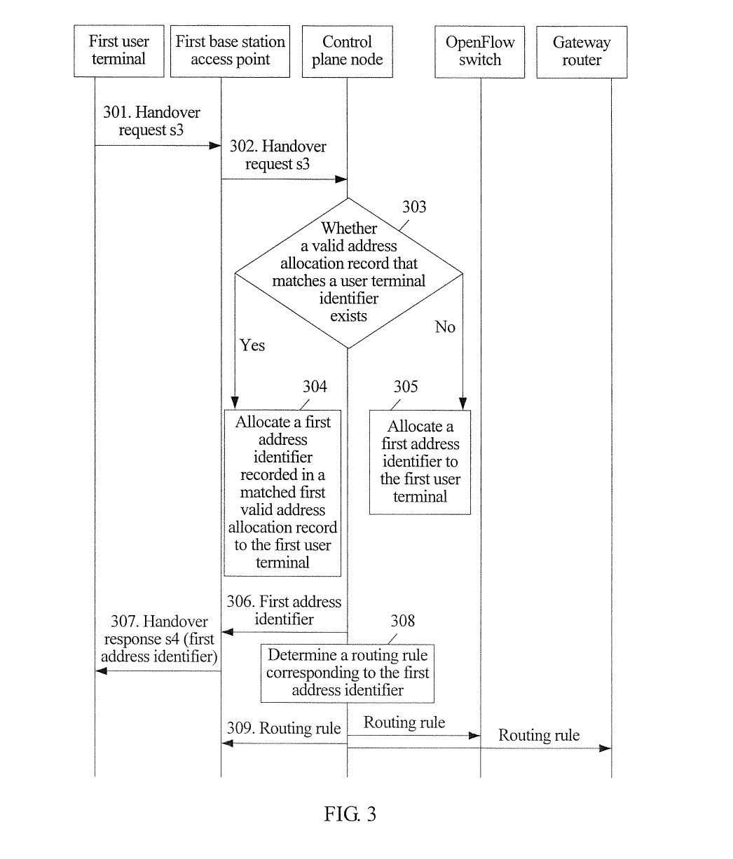

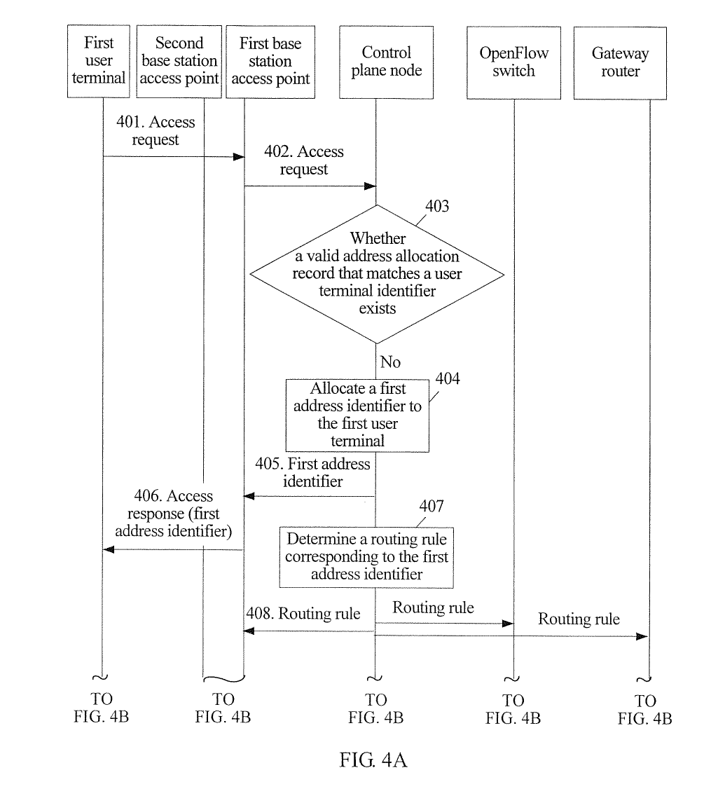

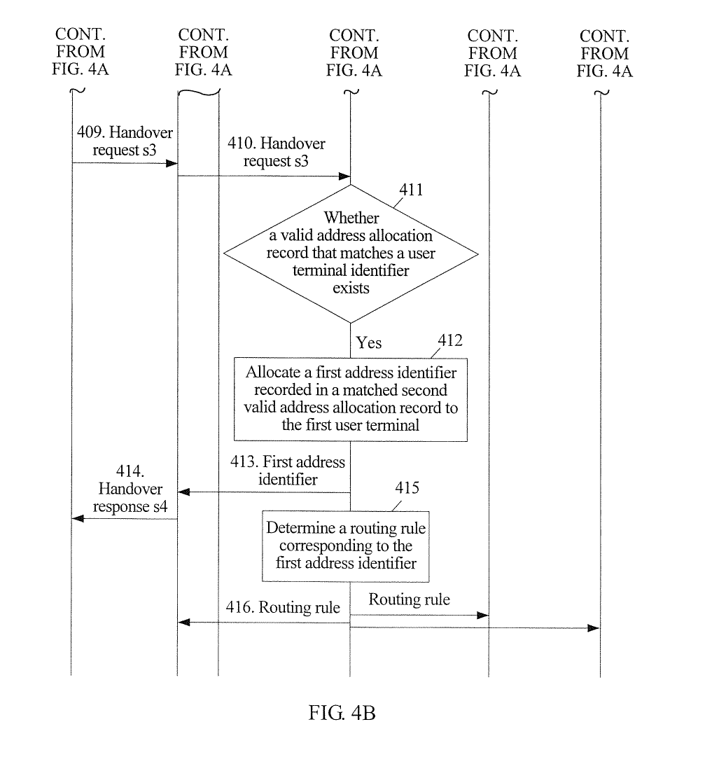

Referring to FIG. 4A and FIG. 4B, FIG. 4A and FIG. 4B are a schematic flowchart of an address identifier allocation method according to another embodiment of the present invention. As shown in FIG. 4A and FIG. 4B, the address identifier allocation method according to the another embodiment of the present invention may include the following content:

401. A first user terminal sends an access request s1 to a first base station access point, where the access request s1 carries a first user terminal identifier.

In an example of this embodiment, the first user terminal is mainly a multimode user terminal.

402. The first base station access point reports the access request s1 to a Single-cNB.

403. The Single-cNB searches a stored valid address allocation record to determine whether a valid address allocation record that matches the first user terminal identifier exists.

In an example of this embodiment, the Single-cNB finds, in the stored valid address allocation record, no valid address allocation record that matches the first user terminal identifier.

404. The Single-cNB allocates a first address identifier to the first user terminal.

The Single-cNB generates a second valid address allocation record based on the first user terminal identifier and the first address identifier, and stores the second valid address allocation record, where the second valid address allocation record records the first user terminal identifier, the first address identifier, and a base station access point identifier corresponding to the first base station access point, or the second valid address allocation record records the first user terminal identifier and the first address identifier.

405. The Single-cNB may send, to the first base station access point, an access response s2 in response to the access request s1, where the access response s2 may carry the first address identifier allocated by the Single-cNB to the first user terminal.

406. The first base station access point sends, to the first user terminal, the access response s2 in response to the access request s1.

407. The Single-cNB determines, based on a preset policy, a routing rule corresponding to the first address identifier.

It may be understood that the routing rule corresponding to the first address identifier is mainly used to perform routing control on a data packet whose source address or destination address is the first address identifier.

The Single-cNB may determine, based on the preset policy, a routing rule r1 corresponding to the first address identifier and the first base station access point, and the Single-cNB may determine, based on the preset policy, a routing rule r2 corresponding to the first address identifier and a gateway router. The Single-cNB deter mines N1 routing rules corresponding to the first address identifier and N1 OpenFlow switches, where the N1 OpenFlow switches are in a one-to-one correspondence with the N1 routing rules.

The N1 OpenFlow switches are OpenFlow switches located on a transmission path between the gateway router and a first user plane access node, where N1 is a positive integer.

408. The Single-cNB sends an OpenFlow protocol message m1 to a gateway router, where a flow entry carried in the OpenFlow protocol message m1 includes a routing rule r2; and the Single-cNB sends an OpenFlow protocol message m2 to the first base station access point, where a flow entry carried in the OpenFlow protocol message m2 includes a routing rule r1.

The Single-cNB sends an OpenFlow protocol message to each OpenFlow switch of the N1 OpenFlow switches, where a flow entry carried in the OpenFlow protocol message sent by the Single-cNB to each OpenFlow switch includes a routing rule, corresponding to each OpenFlow switch, in the N1 routing rules.

So far, when the first user terminal needs to communicate with an external network (for example, the Internet), the first user terminal communicates with the external network by using the first address identifier allocated by the Single-cNB to the first user terminal and by using a data path including the first base station access point, the gateway router, and the N1 OpenFlow switches. The data path herein includes two main parts: air-interface communication (between the first user terminal and the first base station access point) and IP communication (between the first base station access point and the gateway router) of a wired SDN mechanism.

The first base station access point, the gateway router, and the N1 OpenFlow switches may perform, based on the routing rule corresponding to the first address identifier, routing control on the data packet whose source address or destination address is the first address identifier.

It may be understood that step 407 or step 408 and step 406 or step 405 may not necessarily be performed in order.

409. The first user terminal sends a handover request s3 to a second base station access point.

The handover request s3 carries the first user terminal identifier.

410. The second base station access point reports the handover request s3 to the Single-cNB.

In this embodiment of the present invention, a specific handover triggering reason or an initiator is not a focus, and may be one or more of multiple handover triggering mechanisms provided that a handover of a user terminal from an old base station access point (the first base station access point) to a new base station access point (the second base station access point) is triggered. For example, a used handover triggering mechanism may be that a user terminal periodically monitors quality of radio channels to the new base station access point and the old base station access point, handover is triggered when a quality difference between the two radio channels reaches a specific threshold, and then a user terminal may send the handover request s3 to the new base station access point (that is, the second base station access point).

In some cases, the new base station access point or the old base station access point may also actively initiate a procedure of handover of the user terminal from the old base station access point to the new base station access point. In this scenario, step 409 may be omitted.

If determining that the handover of the user terminal from the old base station access point to the new base station access point is permitted, the Single-cNB may allocate a radio resource of the new base station access point to the user terminal. In an example of this embodiment, the Single-cNB determines that the handover of the user terminal from the old base station access point to the new base station access point is permitted.

The second base station access point and the first base station access point belong to networks of different standards. For example, the second base station access point is a base station access point in a cellular network, and the first base station access point is a base station access point in a WiFi network; or the first base station access point is a base station access point in a cellular network, and the second base station access point is a base station access point in a WiFi network. Certainly, the second base station access point and the first base station access point may also belong to networks of a same standard.

411. The Single-cNB searches the stored valid address allocation record to determine whether a valid address allocation record that matches the first user terminal identifier exists.

Because, in step 404, the Single-cNB generates and stores the second valid address allocation record that matches the first user terminal identifier (that is, the stored valid address allocation record includes the second valid address allocation record), the Single-cNB may find, in the stored valid address allocation record, the valid address allocation record (that is, the second valid address allocation record) that matches the first user terminal identifier.

412. The Single-cNB may allocate the first address identifier recorded in the second valid address allocation record to the first user terminal.

In some embodiments of the present invention, the Single-cNB may further replace, with a base station access point identifier corresponding to the second base station access point, the base station access point identifier that is recorded in the second valid address allocation record and that is corresponding to the first base station access point.

413. The Single-cNB may send, to the second base station access point, a handover response s4 in response to the handover request s3, where the handover response s4 may carry the first address identifier allocated to the first user terminal.

414. The second base station access point sends, to the first user terminal, the handover response s4 in response to the handover request s3.

415. The Single-cNB determines, based on the preset policy, a routing rule corresponding to the first address identifier.

It may be understood that the routing rule corresponding to the first address identifier is mainly used to perform routing control on the data packet whose source address or destination address is the first address identifier.

The Single-cNB may determine, based on the preset policy, a routing rule r3 corresponding to the first address identifier and the second base station access point, and the Single-cNB may determine, based on the preset policy, a routing rule r4 corresponding to the first address identifier and the gateway router. The Single-cNB determines N2 routing rules corresponding to the first address identifier and N2 OpenFlow switches, where the N2 OpenFlow switches are in a one-to-one correspondence with the N2 routing rules.

The N2 OpenFlow switches are OpenFlow switches located on a transmission path between the gateway router and the second base station access point, where N2 is a positive integer.

416. The Single-cNB sends an OpenFlow protocol message m3 to the gateway router, where a flow entry carried in the OpenFlow protocol message m3 includes a routing rule r4; and the Single-cNB sends an OpenFlow protocol message m4 to the second base station access point, where a flow entry carried in the OpenFlow protocol message m4 includes a routing rule r3.

The Single-cNB sends an OpenFlow protocol message to each OpenFlow switch of the N2 OpenFlow switches, where a flow entry carried in the OpenFlow protocol message sent by the Single-cNB to each OpenFlow switch includes a routing rule, corresponding to each OpenFlow switch, in the N2 routing rules.

So far, when the first user terminal needs to communicate with an external network, the first user terminal communicates with the external network by using the first address identifier allocated by the Single-cNB to the first user terminal and by using a data path including the second base station access point, the gateway router, and the N2 OpenFlow switches. The data path herein includes two main parts: air-interface communication (between the first user terminal and the second base station access point) and IP communication (between the second base station access point and the gateway router) of a wired SDN mechanism.

The second base station access point, the gateway router, and the N2 OpenFlow switches may perform, based on the routing rule corresponding to the first address identifier, routing control on the data packet whose source address or destination address is the first address identifier.

It may be understood that step 412 or step 413 and step 414 or step 415 may not necessarily be performed in order.

It may be understood in this embodiment that the Single-cNB determines a routing rule corresponding to the first address identifier and an OpenFlow switch is mainly used as an example for description. Certainly, the gateway router may also determine a routing rule corresponding to the first address identifier and an OpenFlow switch, and the gateway router may deliver, to the OpenFlow switch, an OpenFlow protocol message carrying the routing rule. Further, a current base station access point may further send a new-path effect-taking notification to the Single-cNB after detecting that a path to the gateway router takes effect. The Single-cNB may further send an old-path routing rule to the gateway router, and the gateway router may delete a routing rule, corresponding to the first address identifier, of an OpenFlow switch on a path to the old base station access point.

It can be learned that, in this embodiment, a unified control plane node Single-cNB, is introduced into a network, and whether in an initial access process of a user terminal or in a network handover process of a user terminal, allocation and management of an address identifier of the user terminal are completed by the unified control plane node, which changes a mode in the prior art in which address identifiers of a user terminal that are corresponding to different networks are respectively managed in the networks. In addition, the control plane node searches a stored valid address allocation record for a valid address allocation record that matches the first user terminal identifier; and if a first valid address allocation record that matches the first user terminal identifier is found in the stored valid address allocation record, allocates a first address identifier recorded in the first valid address allocation record to a first user terminal indicated by the first user terminal identifier. It can be learned that using the unified control plane node helps ensure that a user terminal uses a same address identifier (for example, an IP address) as possible when being handed over to a different network or performing access by using different user plane access nodes of a same network, and using a same address identifier in these scenarios helps significantly simplify complexity of management of cross-network or cross-access node communication of user data, and further helps simplify a routing rule of a user data packet.

The following further provides related apparatuses for implementing the foregoing solution.

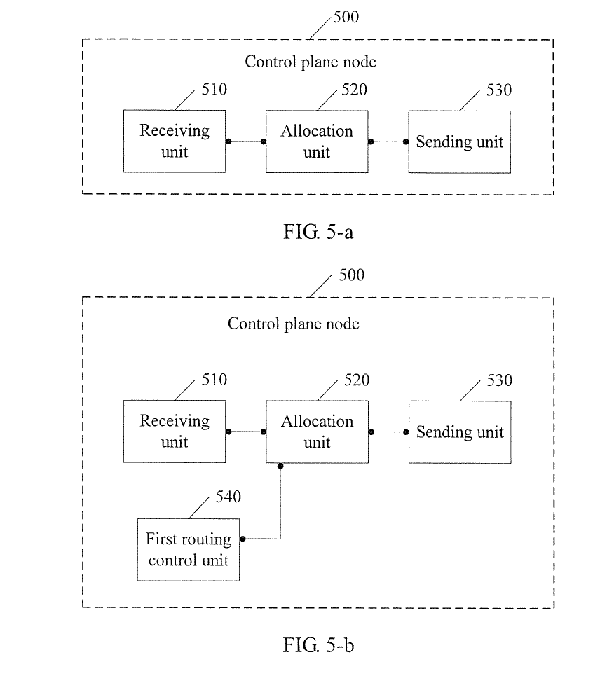

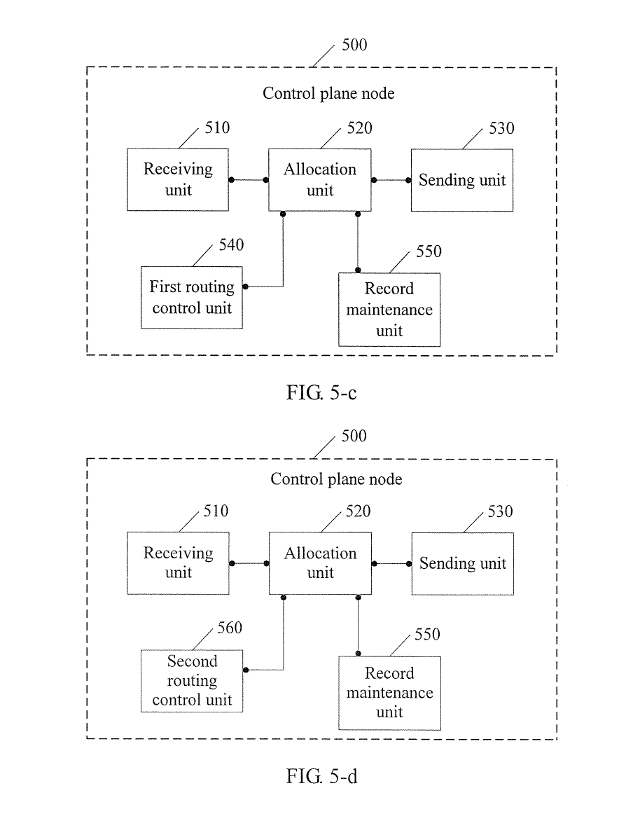

Referring to FIG. 5-a, an embodiment of the present invention provides a control plane node 500, which may include:

a receiving unit 510, an allocation unit 520, and a sending unit 530.

The receiving unit 510 is configured to receive a first service request message that is from a first user plane access node and that carries a first user terminal identifier, where the first service request message is an access request message or a handover request message.

The allocation unit 520 is configured to: search a stored valid address allocation record for a valid address allocation record that matches the first user terminal identifier, and if a first valid address allocation record that matches the first user terminal identifier is found in the stored valid address allocation record, allocate a first address identifier recorded in the first valid address allocation record to a first user terminal indicated by the first user terminal identifier.

The sending unit 530 is configured to send, to the first user plane access node, a first request response message in response to the first service request message, where the first request response message carries the first address identifier, so that the first user plane access node notifies the first user terminal of the first address identifier.

In some embodiments of the present invention, the first valid address allocation record further records a user plane access node identifier, where a user plane access node indicated by the user plane access node identifier and the first user plane access node belong to networks of a same standard, or a user plane access node indicated by the user plane access node identifier and the first user plane access node belong to networks of different standards.

Referring to FIG. 5-b, in some embodiments of the present invention, the control plane node 500 may further include a first routing control unit 540, configured to: after the allocation unit 520 allocates the first address identifier recorded in the first valid address allocation record to the first user terminal indicated by the first user terminal identifier, determine a first routing rule corresponding to the first address identifier and a gateway router, and notify the gateway router of the first routing rule.

In some embodiments of the present invention, the first routing control unit 540 is further configured to: after the allocation unit 520 allocates the first address identifier recorded in the first valid address allocation record to the first user terminal indicated by the first user terminal identifier, determine N1 routing rules corresponding to the first address identifier and N1 OpenFlow switches, and send the N1 routing rules to the N1 OpenFlow switches, where a routing rule sent to each OpenFlow switch of the N1 OpenFlow switches is a routing rule in the N1 routing rules that is in a one-to-one correspondence with each OpenFlow switch, the N1 OpenFlow switches are OpenFlow switches located on a transmission path between the gateway router and the first user plane access node, and N1 is a positive integer.

In some embodiments of the present invention, the first routing control unit 540 may be further configured to: after the allocation unit 520 allocates the first address identifier recorded in the first valid address allocation record to the first user terminal indicated by the first user terminal identifier, determine a second routing rule corresponding to the first address identifier and the first user plane access node, and notify the first user plane access node of the second routing rule.

In some embodiments of the present invention, the receiving unit 510 may be further configured to: after the sending unit 530 sends, to the first user plane access node, the first request response message in response to the first service request message, receive a second service request message that is from a second user plane access node and that carries the first user terminal identifier, where the second service request message is an access request message or a handover request message, and the second user plane access node and the first user plane access node belong to networks of a same standard or different standards.

The allocation unit 520 is further configured to: if the first valid address allocation record that matches the first user terminal identifier is found in the stored valid address allocation record, allocate the first address identifier recorded in the first valid address allocation record to the first user terminal.

The sending unit 530 is further configured to send, to the second user plane access node, a second request response message in response to the second service request message, where the second request response message carries the first address identifier, so that the second user plane access node notifies the first user terminal of the first address identifier.

In some embodiments of the present invention, the allocation unit 520 is further configured to: if no valid address allocation record that matches the first user terminal identifier is found in the stored valid address allocation record, allocate a second address identifier to the first user terminal.

The sending unit 530 is further configured to send, to the first user plane access node, a second request response message in response to the first service request message, where the second request response message carries the second address identifier, so that the first user plane access node notifies the first user terminal of the second address identifier.

Referring to FIG. 5-c, in some embodiments of the present invention, the control plane node 500 further includes:

a record maintenance unit 550, configured to: generate a second valid address allocation record based on the first user terminal identifier and the first address identifier, and store the second valid address allocation record, where the second valid address allocation record records the first user terminal identifier, the first address identifier, and a user plane access node identifier corresponding to the first user plane access node, or the second valid address allocation record records the first user terminal identifier and the first address identifier.

Referring to FIG. 5-d, in some embodiments of the present invention, the control plane node 500 further includes a second routing control unit 560, configured to: after the allocation unit allocates the second address identifier to the first user terminal, determine a third routing rule corresponding to the second address identifier and the gateway router, and notify the gateway router of the third routing rule.

In some embodiments of the present invention, the second routing control unit 560 is further configured to: after the allocation unit allocates the second address identifier to the first user terminal, determine N2 routing rules corresponding to the second address identifier and the N2 OpenFlow switches, and send the N2 routing rules to the N2 OpenFlow switches, where a routing rule sent to each OpenFlow switch of the N2 OpenFlow switches is a routing rule in the N2 routing rules that is in a one-to-one correspondence with each OpenFlow switch, the N2 OpenFlow switches are the OpenFlow switches located on the transmission path between the gateway router and the first user plane access node, and N2 is a positive integer.

In some embodiments of the present invention, the second routing control unit 560 is further configured to: after the allocation unit allocates the second address identifier to the first user terminal, determine a fourth routing rule corresponding to the second address identifier and the first user plane access node, and notify the first user plane access node of the fourth routing rule.

In some embodiments of the present invention, the receiving unit 510 is further configured to: after the sending unit 530 sends, to the first user plane access node, the second request response message in response to the first service request message, receive a second service request message that is from a third user plane access node and that carries the first user terminal identifier, where the second service request message is an access request message or a handover request message, and the third user plane access node and the first user plane access node belong to networks of a same standard or different standards.

The allocation unit 520 is further configured to: if the second valid address allocation record that matches the first user terminal identifier is found in the stored valid address allocation record, allocate the second address identifier recorded in the second valid address allocation record to the first user terminal.

The sending unit 530 is further configured to send, to the third user plane access node, a third request response message in response to the second service request message, where the third request response message carries the second address identifier, so that the third user plane access node notifies the first user terminal of the second address identifier.

In some embodiments of the present invention, the first address identifier may include at least one of the following address identifiers: an Internet Protocol address, a Media Access Control address, and/or a network-wide unique user name (the user name may be a character string, a digit string, or another user name that is network-wide unique).

In some embodiments of the present invention, the second address identifier may include at least one of the following address identifiers: an Internet Protocol address, a Media Access Control address, and/or a network-wide unique user name (the user name may be a character string, a digit string, or another user name that is network-wide unique).

In some embodiments of the present invention, the control plane node 500 may further configure an aging time for a valid address allocation record, and the record maintenance unit 550 may delete a valid address allocation record whose aging time expires, or the record maintenance unit 550 may mark a valid address allocation record whose aging time expires as an invalid address allocation record.

It may be understood that functions of functional modules of the control plane node 500 in this embodiment may be specifically implemented according to the methods in the foregoing method embodiments. For a specific implementation process, refer to related descriptions of the foregoing method embodiments, and details are not described herein again.

It can be learned that, in this embodiment, a unified control plane node is introduced into a network, and whether in an initial access process of a user terminal or in a network handover process of a user terminal, allocation and management of an address identifier of the user terminal are completed by the unified control plane node, which changes a mode in the prior art in which address identifiers of a user terminal that are corresponding to different networks are respectively managed in the networks. In addition, the control plane node searches a stored valid address allocation record for a valid address allocation record that matches the first user terminal identifier; and if a first valid address allocation record that matches the first user terminal identifier is found in the stored valid address allocation record, allocates a first address identifier recorded in the first valid address allocation record to a first user terminal indicated by the first user terminal identifier. It can be learned that using the unified control plane node helps ensure that a user terminal uses a same address identifier (for example, an IP address) as possible when being handed over to a different network or performing access by using different user plane access nodes of a same network, and using a same address identifier in these scenarios helps significantly simplify complexity of management of cross-network or cross-access node communication of user data, and further helps simplify a routing rule of a user data packet.

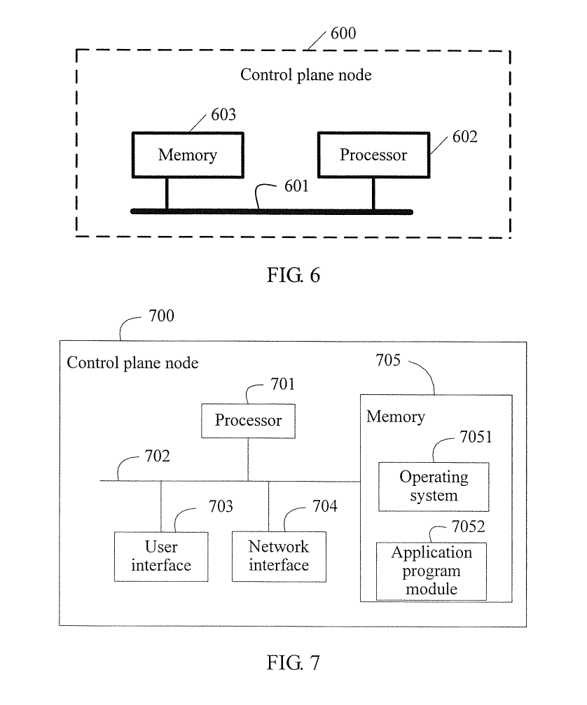

Referring to FIG. 6, FIG. 6 is a schematic diagram of a control plane node 600 according to an embodiment of the present invention. The control plane node 600 may include at least one bus 601, at least one processor 602 connected to the bus 601, and at least one memory 603 connected to the bus 601.

By invoking, by using the bus 601, code stored in the memory 603, the processor 602 is configured to: receive a first service request message that is from a first user plane access node and that carries a first user terminal identifier, where the first service request message is an access request message or a handover request message; search a stored valid address allocation record for a valid address allocation record that matches the first user terminal identifier; if a first valid address allocation record that matches the first user terminal identifier is found in the stored valid address allocation record, allocate a first address identifier recorded in the first valid address allocation record to a first user terminal indicated by the first user terminal identifier; and send, to the first user plane access node, a first request response message in response to the first service request message, where the first request response message carries the first address identifier, so that the first user plane access node notifies the first user terminal of the first address identifier.

In some embodiments of the present invention, the first user terminal is a multimode user terminal or a single-mode user terminal.

In some embodiments of the present invention, the stored valid address allocation record may be preconfigured in the control plane node 600, or may be generated by the processor 602 according to a previous network access or handover status of a user terminal.

In some embodiments of the present invention, each valid address allocation record of the stored valid address allocation record may further record a user plane access node identifier. For example, the first valid address allocation record further records a user plane access node identifier, where a user plane access node indicated by the user plane access node identifier and the first user plane access node are corresponding to a same network standard or different network standards.

In some embodiments of the present invention, the first valid address allocation record further records a user plane access node identifier, where a user plane access node indicated by the user plane access node identifier and the first user plane access node belong to networks of a same standard, for example, standards of both a network to which the user plane access node indicated by the user plane access node identifier belongs and a network to which the first user plane access node belongs are cellular networks (for example, LTE) or WiFi networks. Alternatively, a user plane access node indicated by the user plane access node identifier and the first user plane access node belong to networks of different standards, for example, a standard of a network to which the user plane access node indicated by the user plane access node identifier belongs is a cellular network (for example, an LTE network), and a standard of a network to which the first user plane access node belongs is WiFi; or a standard of a network to which the user plane access node indicated by the user plane access node identifier belongs is WiFi, and a standard of a network to which the first user plane access node belongs is a cellular network (for example, an LTE network).

In some embodiments of the present invention, the first user terminal may be a multimode user terminal.

In some embodiments of the present invention, by invoking, by using the bus 601, the code stored in the memory 603, the processor 602 is further configured to: after allocating the first address identifier recorded in the first valid address allocation record to the first user terminal indicated by the first user terminal identifier, determine a first routing rule corresponding to the first address identifier and a gateway router, and notify the gateway router of the first routing rule.

In some embodiments of the present invention, further, by invoking, by using the bus 601, the code stored in the memory 603, the processor 602 is further configured to: after allocating the first address identifier recorded in the first valid address allocation record to the first user terminal indicated by the first user terminal identifier, determine N1 routing rules corresponding to the first address identifier and N1 OpenFlow switches, and send the N1 routing rules to the N1 OpenFlow switches, where a routing rule sent to each OpenFlow switch of the N1 OpenFlow switches is a routing rule in the N1 routing rules that is in a one-to-one correspondence with each OpenFlow switch, the N1 OpenFlow switches are OpenFlow switches located on a transmission path between the gateway router and the first user plane access node, and N1 is a positive integer.

In some embodiments of the present invention, by invoking, by using the bus 601, the code stored in the memory 603, the processor 602 is further configured to: after allocating the first address identifier recorded in the first valid address allocation record to the first user terminal indicated by the first user terminal identifier, determine a second routing rule corresponding to the first address identifier and the first user plane access node, and notify the first user plane access node of the second routing rule.

In some embodiments of the present invention, by invoking, by using the bus 601, the code stored in the memory 603, the processor 602 is further configured to: after sending, to the first user plane access node, the first request response message in response to the first service request message, receive a second service request message that is from a second user plane access node and that carries the first user terminal identifier, where the second service request message is an access request message or a handover request message, and the second user plane access node and the first user plane access node belong to networks of different standards; if the first valid address allocation record that matches the first user terminal identifier is found in the stored valid address allocation record (the stored valid address allocation record includes the first valid address allocation record), allocate the first address identifier recorded in the first valid address allocation record to the first user terminal; and send, to the second user plane access node, a second request response message in response to the second service request message, where the second request response message carries the first address identifier, so that the second user plane access node notifies the first user terminal of the first address identifier.

In some embodiments of the present invention, the first address identifier may include at least one of the following address identifiers: an Internet Protocol address, a Media Access Control address, and/or a network-wide unique user name (the user name may be a character string, a digit string, or another user name that is network-wide unique).

In some embodiments of the present invention, by invoking, by using the bus 601, the code stored in the memory 603, the processor 602 is further configured to: if no valid address allocation record that matches the first user terminal identifier is found in the stored valid address allocation record, allocate a second address identifier to the first user terminal, and send, to the first user plane access node, a second request response message in response to the first service request message, where the second request response message carries the second address identifier, so that the first user plane access node notifies the first user terminal of the second address identifier.

In some embodiments of the present invention, by invoking, by using the bus 601, the code stored in the memory 603, the processor 602 is further configured to: generate a second valid address allocation record, where the second valid address allocation record records the first user terminal identifier and the first address identifier, or the second valid address allocation record records the first user terminal identifier, the first address identifier, and a user plane access node identifier corresponding to the first user plane access node.

In some embodiments of the present invention, by invoking, by using the bus 601, the code stored in the memory 603, the processor 602 is further configured to: after allocating the second address identifier to the first user terminal, determine a third routing rule corresponding to the second address identifier and the gateway router, and notify the gateway router of the third routing rule.

In some embodiments of the present invention, by invoking, by using the bus 601, the code stored in the memory 603, the processor 602 is further configured to: after allocating the second address identifier to the first user terminal, determine N2 routing rules corresponding to the second address identifier and the N2 OpenFlow switches, and send the N2 routing rules to the N2 OpenFlow switches, where a routing rule sent to each OpenFlow switch of the N2 OpenFlow switches is a routing rule in the N2 routing rules that is in a one-to-one correspondence with each OpenFlow switch, the N2 OpenFlow switches are the OpenFlow switches located on the transmission path between the gateway router and the first user plane access node, and N1 is a positive integer.

In some embodiments of the present invention, by invoking, by using the bus 601, the code stored in the memory 603, the processor 602 is further configured to: after allocating the second address identifier to the first user terminal, determine a fourth routing rule corresponding to the second address identifier and the first user plane access node, and notify the first user plane access node of the fourth routing rule.

In some embodiments of the present invention, by invoking, by using the bus 601, the code stored in the memory 603, the processor 602 is further configured to: after sending, to the first user plane access node, the second request response message in response to the first service request message, receive a second service request message that is from a third user plane access node and that carries the first user terminal identifier, where the second service request message is an access request message or a handover request message, and the third user plane access node and the first user plane access node belong to networks of a same standard or different standards; if the second valid address allocation record that matches the first user terminal identifier is found in the stored valid address allocation record, allocate the second address identifier recorded in the second valid address allocation record to the first user terminal; and send, to the third user plane access node, a third request response message in response to the second service request message, where the third request response message carries the second address identifier, so that the third user plane access node notifies the first user terminal of the second address identifier.

In some embodiments of the present invention, the second address identifier may include at least one of the following address identifiers: an Internet Protocol address, a Media Access Control address, and/or a network-wide unique user name (the user name may be a character string, a digit string, or another user name that is network-wide unique).

In some embodiments of the present invention, the control plane node 600 may further configure an aging time for a valid address allocation record, and by invoking, by using the bus 601, the code stored in the memory 603, the processor 602 is further configured to: delete a valid address allocation record whose aging time expires, or mark a valid address allocation record whose aging time expires as an invalid address allocation record.

It may be understood that functions of functional modules of the control plane node 600 in this embodiment may be specifically implemented according to the methods in the foregoing method embodiments. For a specific implementation process, refer to related descriptions of the foregoing method embodiments, and details are not described herein again.

It can be learned that, in this embodiment, a unified control plane node is introduced into a network, and whether in an initial access process of a user terminal or in a network handover process of a user terminal, allocation and management of an address identifier of the user terminal are completed by the unified control plane node, which changes a mode in the prior art in which address identifiers of a user terminal that are corresponding to different networks are respectively managed in the networks. In addition, the control plane node searches a stored valid address allocation record for a valid address allocation record that matches the first user terminal identifier; and if a first valid address allocation record that matches the first user terminal identifier is found in the stored valid address allocation record, allocates a first address identifier recorded in the first valid address allocation record to a first user terminal indicated by the first user terminal identifier. It can be learned that using the unified control plane node helps ensure that a user terminal uses a same address identifier (for example, an IP address) as possible when being handed over to a different network or performing access by using different user plane access nodes of a same network, and using a same address identifier in these scenarios helps significantly simplify complexity of management of cross-network or cross-access node communication of user data, and further helps simplify a routing rule of a user data packet.

Referring to FIG. 7, FIG. 7 is a structural block diagram of a control plane node 700 according to another embodiment of the present invention.

The control plane node 700 may include at least one processor 701, at least one network interface 704 or another user interface 703, a memory 705, and at least one communications bus 702. The communications bus 702 is configured to implement a connection and communication between these components. The control plane node 700 optionally includes a user interface 703 that includes a display (for example, a touchscreen, an LCD, a CRT, a holographic imaging device (Holographic), or a projector (Projector)), a click device (for example, a mouse, a trackball (trackball), a touchpad, or a touchscreen), a camera, an audio monitoring apparatus, and/or the like.

The memory 705 may include, for example, a read-only memory and a random access memory, and provide instructions and data for the processor 701.

A part of the memory 705 further includes a nonvolatile random access memory (NVRAM), and the like.

In some implementation manners, the memory 705 stores the following elements, an executable module or a data structure, or a subset thereof, or an extended set thereof:

an operating system 7051, including various system programs, and configured to implement various basic services and process a hardware-based task; and

an application program module 7052, including various application programs, and configured to implement various application services.

For example, the application program module 7052 includes at least one of the following units: a receiving unit 510, an allocation unit 520, a sending unit 530, a first routing control unit 540, a record maintenance unit 550, and a second routing control unit 560.

In this embodiment of the present invention, by invoking a program or an instruction stored in the memory 705, the processor 701 receives a first service request message that is from a first user plane access node and that carries a first user terminal identifier, where the first service request message is an access request message or a handover request message; searches a stored valid address allocation record for a valid address allocation record that matches the first user terminal identifier; if a first valid address allocation record that matches the first user terminal identifier is found in the stored valid address allocation record, allocates a first address identifier recorded in the first valid address allocation record to a first user terminal indicated by the first user terminal identifier; and sends, to the first user plane access node, a first request response message in response to the first service request message, where the first request response message carries the first address identifier, so that the first user plane access node notifies the first user terminal of the first address identifier.

In some embodiments of the present invention, the first user terminal may be a multimode user terminal or a single-mode user terminal.

In some embodiments of the present invention, the stored valid address allocation record may be preconfigured in the control plane node 700, or may be generated by the processor 701 according to a previous network access or handover status of a user terminal.

In some embodiments of the present invention, each valid address allocation record of the stored valid address allocation record may further record a user plane access node identifier. For example, the first valid address allocation record further records a user plane access node identifier, where a user plane access node indicated by the user plane access node identifier and the first user plane access node are corresponding to a same network standard or different network standards.

In some embodiments of the present invention, the first valid address allocation record further records a user plane access node identifier, where a user plane access node indicated by the user plane access node identifier and the first user plane access node belong to networks of a same standard, for example, standards of both a network to which the user plane access node indicated by the user plane access node identifier belongs and a network to which the first user plane access node belongs are cellular networks (for example, LTE networks) or WiFi networks. Alternatively, a user plane access node indicated by the user plane access node identifier and the first user plane access node belong to networks of different standards, for example, a standard of a network to which the user plane access node indicated by the user plane access node identifier belongs is a cellular network (for example, LTE), and a standard of a network to which the first user plane access node belongs is WiFi; or a standard of a network to which the user plane access node indicated by the user plane access node identifier belongs is WiFi, and a standard of a network to which the first user plane access node belongs is a cellular network (for example, LTE).

In some embodiments of the present invention, the first user terminal may be a multimode user terminal.

In some embodiments of the present invention, by invoking the program or the instruction stored in the memory 705, the processor 701 may be further configured to: after allocating the first address identifier recorded in the first valid address allocation record to the first user terminal indicated by the first user terminal identifier, determine a first routing rule corresponding to the first address identifier and a gateway router, and notify the gateway router of the first routing rule.

In some embodiments of the present invention, by invoking the program or the instruction stored in the memory 705, the processor 701 is further configured to: after allocating the first address identifier recorded in the first valid address allocation record to the first user terminal indicated by the first user terminal identifier, determine N1 routing rules corresponding to the first address identifier and N1 OpenFlow switches, and send the N1 routing rules to the N1 OpenFlow switches, where a routing rule sent to each OpenFlow switch of the N1 OpenFlow switches is a routing rule in the N1 routing rules that is in a one-to-one correspondence with each OpenFlow switch, the N1 OpenFlow switches are OpenFlow switches located on a transmission path between the gateway router and the first user plane access node, and N1 is a positive integer.

In some embodiments of the present invention, by invoking the program or the instruction stored in the memory 705, the processor 701 is further configured to: after allocating the first address identifier recorded in the first valid address allocation record to the first user terminal indicated by the first user terminal identifier, determine a second routing rule corresponding to the first address identifier and the first user plane access node, and notify the first user plane access node of the second routing rule.

In some embodiments of the present invention, by invoking the program or the instruction stored in the memory 705, the processor 701 is further configured to: after sending, to the first user plane access node, the first request response message in response to the first service request message, receive a second service request message that is from a second user plane access node and that carries the first user terminal identifier, where the second service request message is an access request message or a handover request message, and the second user plane access node and the first user plane access node belong to networks of different standards; if the first valid address allocation record that matches the first user terminal identifier if found in the stored valid address allocation record (the stored valid address allocation record includes the first valid address allocation record), allocate the first address identifier recorded in the first valid address allocation record to the first user terminal; and send, to the second user plane access node, a second request response message in response to the second service request message, where the second request response message carries the first address identifier.

In some embodiments of the present invention, the first address identifier may include at least one of the following address identifiers: an Internet Protocol address, a Media Access Control address, and/or a network-wide unique user name (the user name may be a character string, a digit string, or another user name that is network-wide unique).

In some embodiments of the present invention, by invoking the program or the instruction stored in the memory 705, the processor 701 is further configured to: if no valid address allocation record that matches the first user terminal identifier is found in the stored valid address allocation record, allocate a second address identifier to the first user terminal, and send, to the first user plane access node, a second request response message in response to the first service request message, where the second request response message carries the second address identifier, so that the first user plane access node notifies the first user terminal of the second address identifier.

In some embodiments of the present invention, by invoking the program or the instruction stored in the memory 705, the processor 701 is further configured to: generate a second valid address allocation record, where the second valid address allocation record records the first user terminal identifier and the first address identifier, or the second valid address allocation record records the first user terminal identifier, the first address identifier, and a user plane access node identifier corresponding to the first user plane access node.

In some embodiments of the present invention, by invoking the program or the instruction stored in the memory 705, the processor 701 is further configured to: after allocating the second address identifier to the first user terminal, determine a third routing rule corresponding to the second address identifier and the gateway router, and notify the gateway router of the third routing rule.

In some embodiments of the present invention, by invoking the program or the instruction stored in the memory 705, the processor 701 is further configured to: after allocating the second address identifier to the first user terminal, determine N2 routing rules corresponding to the second address identifier and the N2 OpenFlow switches, and send the N2 routing rules to the N2 OpenFlow switches, where a routing rule sent to each OpenFlow switch of the N2 OpenFlow switches is a routing rule in the N2 routing rules that is in a one-to-one correspondence with each OpenFlow switch, the N2 OpenFlow switches are the OpenFlow switches located on the transmission path between the gateway router and the first user plane access node, and N2 is a positive integer.

In some embodiments of the present invention, by invoking the program or the instruction stored in the memory 705, the processor 701 is further configured to: after allocating the second address identifier to the first user terminal, determine a fourth routing rule corresponding to the second address identifier and the first user plane access node, and notify the first user plane access node of the fourth routing rule.

In some embodiments of the present invention, by invoking the program or the instruction stored in the memory 705, the processor 701 is further configured to: after sending, to the first user plane access node, the second request response message in response to the first service request message, receive a second service request message that is from a third user plane access node and that carries the first user terminal identifier, where the second service request message is an access request message or a handover request message, and the third user plane access node and the first user plane access node belong to networks of a same standard or different standards; if the second valid address allocation record that matches the first user terminal identifier is found in the stored valid address allocation record, allocate the second address identifier recorded in the second valid address allocation record to the first user terminal; and send, to the third user plane access node, a third request response message in response to the second service request message, where the third request response message carries the second address identifier, so that the third user plane access node notifies the first user terminal of the second address identifier.

In some embodiments of the present invention, the second address identifier may include at least one of the following address identifiers: an Internet Protocol address, a Media Access Control address, and/or a network-wide unique user name (the user name may be a character string, a digit string, or another user name that is network-wide unique).

In some embodiments of the present invention, the control plane node 700 may further configure an aging time for a valid address allocation record, and by invoking the program or the instruction stored in the memory 705, the processor 701 is further configured to: delete a valid address allocation record whose aging time expires, or mark a valid address allocation record whose aging time expires as an invalid address allocation record.

It may be understood that functions of functional modules of the control plane node 700 in this embodiment may be specifically implemented according to the methods in the foregoing method embodiments. For a specific implementation process, refer to related descriptions of the foregoing method embodiments, and details are not described herein again.

It can be learned that, in this embodiment, a unified control plane node 700 is introduced into a network, and whether in an initial access process of a user terminal or in a network handover process of a user terminal, allocation and management of an address identifier of the user terminal are completed by the unified control plane node, which changes a mode in the prior art in which address identifiers of a user terminal that are corresponding to different networks are respectively managed in the networks. In addition, the control plane node searches a stored valid address allocation record for a valid address allocation record that matches the first user terminal identifier; and if a first valid address allocation record that matches the first user terminal identifier is found in the stored valid address allocation record, allocates a first address identifier recorded in the first valid address allocation record to a first user terminal indicated by the first user terminal identifier. It can be learned that using the unified control plane node helps ensure that a user terminal uses a same address identifier (for example, an IP address) as possible when being handed over to a different network or performing access by using different user plane access nodes of a same network, and using a same address identifier in these scenarios helps significantly simplify complexity of management of cross-network or cross-access node communication of user data, and further helps simplify a routing rule of a user data packet.

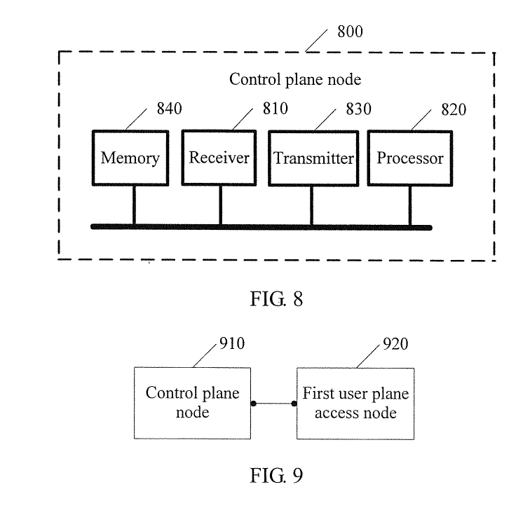

Referring to FIG. 8, an embodiment of the present invention further provides a control plane node 800, which may include:

a receiver 810, a processor 820, a transmitter 830, and a memory 840.

The receiver 810 is configured to receive a first service request message that is from a first user plane access node and that carries a first user terminal identifier, where the first service request message is an access request message or a handover request message.

The processor 820 is configured to: search a valid address allocation record stored in the memory 840 for a valid address allocation record that matches the first user terminal identifier, and if a first valid address allocation record that matches the first user terminal identifier is found in the valid address allocation record stored in the memory 840, allocate a first address identifier recorded in the first valid address allocation record to a first user terminal indicated by the first user terminal identifier.

The transmitter 830 is configured to send, to the first user plane access node, a first request response message in response to the first service request message, where the first request response message carries the first address identifier, so that the first user plane access node notifies the first user terminal of the first address identifier.

In some embodiments of the present invention, the first valid address allocation record further records a user plane access node identifier, where a user plane access node indicated by the user plane access node identifier and the first user plane access node belong to networks of a same standard, or a user plane access node indicated by the user plane access node identifier and the first user plane access node belong to networks of different standards.

In some embodiments of the present invention, the processor 820 is further configured to: after allocating the first address identifier recorded in the first valid address allocation record to the first user terminal indicated by the first user terminal identifier, determine a first routing rule corresponding to the first address identifier and a gateway router, and notify the gateway router of the first routing rule.

In some embodiments of the present invention, the processor 820 is further configured to: after allocating the first address identifier recorded in the first valid address allocation record to the first user terminal indicated by the first user terminal identifier, determine N1 routing rules corresponding to the first address identifier and N1 OpenFlow switches, and send the N1 routing rules to the N1 OpenFlow switches, where a routing rule sent to each OpenFlow switch of the N1 OpenFlow switches is a routing rule in the N1 routing rules that is in a one-to-one correspondence with each OpenFlow switch, the N1 OpenFlow switches are OpenFlow switches located on a transmission path between the gateway router and the first user plane access node, and N1 is a positive integer.

In some embodiments of the present invention, the processor 820 is further configured to: after allocating the first address identifier recorded in the first valid address allocation record to the first user terminal indicated by the first user terminal identifier, determine a second routing rule corresponding to the first address identifier and the first user plane access node, and notify the first user plane access node of the second routing rule.

In some embodiments of the present invention, the receiver 810 may be further configured to: after the transmitter 830 sends, to the first user plane access node, the first request response message in response to the first service request message, receive a second service request message that is from a second user plane access node and that carries the first user terminal identifier, where the second service request message is an access request message or a handover request message, and the second user plane access node and the first user plane access node belong to networks of a same standard or different standards.

The processor 820 is further configured to: if the first valid address allocation record that matches the first user terminal identifier is found in the valid address allocation record stored in the memory 840, allocate the first address identifier recorded in the first valid address allocation record to the first user terminal.

The transmitter 830 is further configured to send, to the second user plane access node, a second request response message in response to the second service request message, where the second request response message carries the first address identifier, so that the second user plane access node notifies the first user terminal of the first address identifier.

In some embodiments of the present invention, the processor 820 is further configured to: if no valid address allocation record that matches the first user terminal identifier is found in the valid address allocation record stored in the memory 840, allocate a second address identifier to the first user terminal.

The transmitter 830 is further configured to send, to the first user plane access node, a second request response message in response to the first service request message, where the second request response message carries the second address identifier, so that the first user plane access node notifies the first user terminal of the second address identifier.

In some embodiments of the present invention, the processor 820 is further configured to: generate a second valid address allocation record based on the first user terminal identifier and the first address identifier, and store the second valid address allocation record in the memory 840, where the second valid address allocation record records the first user terminal identifier, the first address identifier, and a user plane access node identifier corresponding to the first user plane access node, or the second valid address allocation record records the first user terminal identifier and the first address identifier.

In some embodiments of the present invention, the processor 820 is further configured to: after allocating the second address identifier to the first user terminal, determine a third routing rule corresponding to the second address identifier and the gateway router, and notify the gateway router of the third routing rule.

In some embodiments of the present invention, the processor 820 is further configured to: after allocating the second address identifier to the first user terminal, determine N2 routing rules corresponding to the second address identifier and the N2 OpenFlow switches, and send the N2 routing rules to the N2 OpenFlow switches, where a routing rule sent to each OpenFlow switch of the N2 OpenFlow switches is a routing rule in the N2 routing rules that is in a one-to-one correspondence with each OpenFlow switch, the N2 OpenFlow switches are the OpenFlow switches located on the transmission path between the gateway router and the first user plane access node, and N2 is a positive integer.

In some embodiments of the present invention, the processor 820 is further configured to: after allocating the second address identifier to the first user terminal, determine a fourth routing rule corresponding to the second address identifier and the first user plane access node, and notify the first user plane access node of the fourth routing rule.

In some embodiments of the present invention, the receiver 810 is further configured to: after the transmitter 830 sends, to the first user plane access node, the second request response message in response to the first service request message, receive a second service request message that is from a third user plane access node and that carries the first user terminal identifier, where the second service request message is an access request message or a handover request message, and the third user plane access node and the first user plane access node belong to networks of a same standard or different standards.

The processor 820 is further configured to: if the second valid address allocation record that matches the first user terminal identifier is found in the valid address allocation record stored in the memory 840, allocate the second address identifier recorded in the second valid address allocation record to the first user terminal.

The transmitter 830 is further configured to send, to the third user plane access node, a third request response message in response to the second service request message, where the third request response message carries the second address identifier, so that the third user plane access node notifies the first user terminal of the second address identifier.

In some embodiments of the present invention, the first address identifier may include at least one of the following address identifiers: an Internet Protocol address, a Media Access Control address, and/or a network-wide unique user name (the user name may be a character string, a digit string, or another user name that is network-wide unique).

In some embodiments of the present invention, the second address identifier may include at least one of the following address identifiers: an Internet Protocol address, a Media Access Control address, and/or a network-wide unique user name (the user name may be a character string, a digit string, or another user name that is network-wide unique).

In some embodiments of the present invention, the control plane node 800 may further configure an aging time for a valid address allocation record, and the processor 820 is further configured to delete a valid address allocation record whose aging time expires, or the processor 820 is further configured to mark a valid address allocation record whose aging time expires as an invalid address allocation record.

It may be understood that functions of functional modules of the control plane node 800 in this embodiment may be specifically implemented according to the methods in the foregoing method embodiments. For a specific implementation process, refer to related descriptions of the foregoing method embodiments, and details are not described herein again.

It can be learned that, in this embodiment, a unified control plane node is introduced into a network, and whether in an initial access process of a user terminal or in a network handover process of a user terminal, allocation and management of an address identifier of the user terminal are completed by the unified control plane node, which changes a mode in the prior art in which address identifiers of a user terminal that are corresponding to different networks are respectively managed in the networks. In addition, the control plane node searches a stored valid address allocation record for a valid address allocation record that matches the first user terminal identifier; and if a first valid address allocation record that matches the first user terminal identifier is found in the stored valid address allocation record, allocates a first address identifier recorded in the first valid address allocation record to a first user terminal indicated by the first user terminal identifier. It can be learned that using the unified control plane node helps ensure that a user terminal uses a same address identifier (for example, an IP address) as possible when being handed over to a different network or performing access by using different user plane access nodes of a same network, and using a same address identifier in these scenarios helps significantly simplify complexity of management of cross-network or cross-access node communication of user data, and further helps simplify a routing rule of a user data packet.

Referring to FIG. 9, an embodiment of the present invention further provides a communications system, which may include: a control plane node 910 and at least one user plane access node 920 including a first user plane access node 920.

The first user plane access node 920 is configured to send, to the control plane node 910, a first service request message carrying a first user terminal identifier.

The control plane node 910 is configured to: receive the first service request message that is from the first user plane access node 920 and that carries the first user terminal identifier, where the first service request message is an access request message or a handover request message; search a stored valid address allocation record for a valid address allocation record that matches the first user terminal identifier; if a first valid address allocation record that matches the first user terminal identifier is found in the stored valid address allocation record, allocate a first address identifier recorded in the first valid address allocation record to a first user terminal indicated by the first user terminal identifier; and send, to the first user plane access node 920, a first request response message in response to the first service request message, where the first request response message carries the first address identifier, so that the first user plane access node 920 notifies the first user terminal of the first address identifier.

In some embodiments of the present invention, the control plane node 910 may locally store one or more valid address allocation records. The one or more valid address allocation records locally stored in the control plane node 910 may be preconfigured in the control plane node 910; certainly, the one or more valid address allocation records locally stored in the control plane node 910 may also be generated by the control plane node 910 according to a previous network access or handover status of a user terminal. Further, the control plane node 910 may update the one or more locally stored valid address allocation records. Certainly, a third-party device may also store one or more valid address allocation records, and the control plane node 910 may search the valid address allocation record stored in the third-party device for a valid address allocation record that matches the first user terminal identifier. Further, the third-party device may update the one or more valid address allocation records stored in the third-party device.

In some embodiments of the present invention, the first user terminal is a multimode user terminal, and certainly, the first user terminal may also be a single-mode user terminal.

In some embodiments of the present invention, each valid address allocation record of the stored valid address allocation record may further record a user plane access node identifier. For example, the first valid address allocation record further records a user plane access node identifier, where a user plane access node indicated by the user plane access node identifier and the first user plane access node 920 are corresponding to a same network standard or different network standards.

In some embodiments of the present invention, the first valid address allocation record further records a user plane access node identifier, where a user plane access node indicated by the user plane access node identifier and the first user plane access node 920 belong to networks of a same standard, for example, standards of both a network to which the user plane access node indicated by the user plane access node identifier belongs and a network to which the first user plane access node 920 belongs are cellular networks (for example, LTE networks) or WiFi networks. Alternatively, a user plane access node indicated by the user plane access node identifier and the first user plane access node 920 belong to networks of different standards, for example, a standard of a network to which the user plane access node indicated by the user plane access node identifier belongs is a cellular network (for example, an LTE network), and a standard of a network to which the first user plane access node 920 belongs is WiFi; or a standard of a network to which the user plane access node indicated by the user plane access node identifier belongs is WiFi, and a standard of a network to which the first user plane access node 920 belongs is a cellular network (for example, an LTE network).

In some embodiments of the present invention, the control plane node 910 may be further configured to: after allocating the first address identifier recorded in the first valid address allocation record to the first user terminal indicated by the first user terminal identifier, determine a first routing rule corresponding to the first address identifier and a gateway router, and notify the gateway router of the first routing rule.

In some embodiments of the present invention, the control plane node 910 may be further configured to: after allocating the first address identifier recorded in the first valid address allocation record to the first user terminal indicated by the first user terminal identifier, determine N1 routing rules corresponding to the first address identifier and N1 OpenFlow switches, and send the N1 routing rules to the N1 OpenFlow switches, where a routing rule sent to each OpenFlow switch of the N1 OpenFlow switches is a routing rule in the N1 routing rules that is in a one-to-one correspondence with each OpenFlow switch, the N1 OpenFlow switches are OpenFlow switches located on a transmission path between the gateway router and the first user plane access node 920, and N1 is a positive integer.

In some embodiments of the present invention, the control plane node 910 may be further configured to: after allocating the first address identifier recorded in the first valid address allocation record to the first user terminal indicated by the first user terminal identifier, determine a second routing rule corresponding to the first address identifier and the first user plane access node 920, and notify the first user plane access node 920 of the second routing rule.

In some embodiments of the present invention, the control plane node 910 may be further configured to: send, to the first user plane access node 920, the first request response message in response to the first service request message, receive a second service request message that is from a second user plane access node and that carries the first user terminal identifier, where the second service request message is an access request message or a handover request message, and the second user plane access node and the first user plane access node 920 belong to networks of different standards; if the first valid address allocation record that matches the first user terminal identifier if found in the stored valid address allocation record (the stored valid address allocation record includes the first valid address allocation record), allocate the first address identifier recorded in the first valid address allocation record to the first user terminal; and send, to the second user plane access node, a second request response message in response to the second service request message, where the second request response message carries the first address identifier, so that the second user plane access node notifies the first user terminal of the first address identifier.

In some embodiments of the present invention, the first address identifier may include at least one of the following address identifiers: an Internet Protocol address, a Media Access Control address, and/or a network-wide unique user name (the user name may be a character string, a digit string, or another user name that is network-wide unique).

In some embodiments of the present invention, the control plane node 910 may be further configured to: if no valid address allocation record that matches the first user terminal identifier is found in the stored valid address allocation record, allocate a second address identifier to the first user terminal, and send, to the first user plane access node 920, a second request response message in response to the first service request message, where the second request response message carries the second address identifier, so that the first user plane access node 920 notifies the first user terminal of the second address identifier.

In some embodiments of the present invention, the control plane node 910 may be further configured to: generate a second valid address allocation record according to the first user terminal identifier and the second address identifier, and store the second valid address allocation record, where the second valid address allocation record records the first user terminal identifier and the second address identifier, or the second valid address allocation record records the first user terminal identifier, the second address identifier, and a user plane access node identifier corresponding to the first user plane access node 920.

In some embodiments of the present invention, the control plane node 910 may be further configured to: after allocating the second address identifier to the first user terminal, determine a third routing rule corresponding to the second address identifier and the gateway router, and notify the gateway router of the third routing rule.

In some embodiments of the present invention, the control plane node 910 may be further configured to: after allocating the second address identifier to the first user terminal, determine N2 routing rules corresponding to the second address identifier and the N2 OpenFlow switches, and send the N2 routing rules to the N2 OpenFlow switches, where a routing rule sent to each OpenFlow switch of the N2 OpenFlow switches is a routing rule in the N2 routing rules that is in a one-to-one correspondence with each OpenFlow switch, the N2 OpenFlow switches are the OpenFlow switches located on the transmission path between the gateway router and the first user plane access node 920, and N2 is a positive integer.

In some embodiments of the present invention, the control plane node 910 may be further configured to: after allocating the second address identifier to the first user terminal, determine a fourth routing rule corresponding to the second address identifier and the first user plane access node 920, and notify the first user plane access node 920 of the fourth routing rule.

In some embodiments of the present invention, the control plane node 910 may be further configured to: after the control plane node 910 sends, to the first user plane access node 920, the second request response message in response to the first service request message, receive a second service request message that is from a third user plane access node and that carries the first user terminal identifier, where the second service request message is an access request message or a handover request message, and the third user plane access node and the first user plane access node 920 belong to networks of a same standard or different standards; if the second valid address allocation record that matches the first user terminal identifier is found in the stored valid address allocation record, allocate the second address identifier recorded in the second valid address allocation record to the first user terminal; and send, to the third user plane access node, a third request response message in response to the second service request message, where the third request response message carries the second address identifier, so that the third user plane access node notifies the first user terminal of the second address identifier.

In some embodiments of the present invention, the second address identifier is an Internet Protocol address, a Media Access Control address, and/or a network-wide unique user name (the user name may be a character string, a digit string, or another user name that is network-wide unique).

In some embodiments of the present invention, the control plane node 910 may be further configured to configure an aging time for a valid address allocation record. The control plane node 910 may be further configured to: delete a valid address allocation record whose aging time expires, or mark a valid address allocation record whose aging time expires as an invalid address allocation record.

It may be understood that the first user plane access node 920 (or the second user plane access node or the third user plane access node), the gateway router, and the N1 OpenFlow switches (or the N2 OpenFlow switches) may perform, based on a routing rule corresponding to the first address identifier (or the second address identifier), routing control on a received data packet whose source address or destination address is the first address identifier (or the second address identifier).

In some embodiments of the present invention, the control plane node 910 may be, for example, the control plane node 500, the control plane node 600, the control plane node 700, or the control plane node 800.

It can be learned that, in this embodiment, a unified control plane node 910 is introduced into a network, and whether in an initial access process of a user terminal or in a network handover process of a user terminal, allocation and management of an address identifier of the user terminal are completed by the unified control plane node 910, which changes a mode in the prior art in which address identifiers of a user terminal that are corresponding to different networks are respectively managed in the networks. In addition, the control plane node searches a stored valid address allocation record for a valid address allocation record that matches the first user terminal identifier; and if a first valid address allocation record that matches the first user terminal identifier is found in the stored valid address allocation record, allocates a first address identifier recorded in the first valid address allocation record to a first user terminal indicated by the first user terminal identifier. It can be learned that using the unified control plane node 910 helps ensure that a user terminal uses a same address identifier as possible when being handed over to a different network or performing access by using different user plane access nodes of a same network, and using a same address identifier in these scenarios helps significantly simplify complexity of management of cross-network or cross-access node communication of user data, and further helps simplify a routing rule of a user data packet.

An embodiment of the present invention further provides a computer storage medium, where the computer storage medium may store a program, and when the program is executed, some or all steps of at least one address identifier allocation method recorded in the foregoing method embodiments are executed.

In the foregoing embodiments, the description of each embodiment has respective focuses. For a part that is not described in detail in an embodiment, reference may be made to related descriptions in other embodiments.

It should be noted that, for brief description, the foregoing method embodiments are represented as a series of actions. However, persons skilled in the art should appreciate that the present invention is not limited to the described order of the actions, because according to the present invention, some steps may be performed in other orders or simultaneously. In addition, persons skilled in the art should also understand that all the embodiments described in this specification belong to exemplary embodiments, and the involved actions and modules are not necessarily mandatory to the present invention.

In the foregoing embodiments, the description of each embodiment has respective focuses. For a part that is not described in detail in an embodiment, reference may be made to related descriptions in other embodiments.

In the several embodiments provided in the present application, it should be understood that the disclosed apparatus may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present invention may be integrated into one processing unit, or each of the units may exist alone physically, or two or more units are integrated into one unit. The integrated unit may be implemented in a form of hardware, or may be implemented in a form of a software functional unit.

When the foregoing integrated unit is implemented in the form of a software functional unit and sold or used as an independent product, the integrated unit may be stored in a computer-readable storage medium. Based on such an understanding, the technical solutions of the present invention essentially, or the part contributing to the prior art, or all or some of the technical solutions may be implemented in the form of a software product. The computer software product is stored in a storage medium and includes several instructions for instructing a computer device (which may be a personal computer, a server, or a network device) to perform all or some of the steps of the methods described in the embodiments of the present invention. The foregoing storage medium includes: any medium that can store program code, such as a USB flash drive, a read-only memory (ROM, Read-Only Memory), a random access memory (RAM, Random Access Memory), a removable hard disk, a magnetic disk, or an optical disc.

The foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of the embodiments of the present invention.

What is claimed is:

1. An address identifier allocation method, comprising:
receiving, by a control plane node, a first service request message that is from a first user plane access node and that carries a first user terminal identifier, wherein the first service request message is an access request message or a handover request message;
searching, by the control plane node, a stored valid address allocation record for a valid address allocation record that matches the first user terminal identifier, and if a first valid address allocation record that matches the first user terminal identifier is found in the stored valid address allocation record, allocating a first address identifier recorded in the first valid address allocation record to a first user terminal indicated by the first user terminal identifier; and
sending, to the first user plane access node by the control plane node, a first request response message in response to the first service request message, wherein the first request response message carries the first address identifier, so that the first user plane access node notifies the first user terminal of the first address identifier.

2. The method according to claim 1, wherein the first valid address allocation record further records a user plane access node identifier, wherein a user plane access node indicated by the user plane access node identifier and the first user plane access node belong to networks of a same standard, or a user plane access node indicated by the user plane access node identifier and the first user plane access node belong to networks of different standards.

3. The method according to claim 1, wherein after allocating a first address identifier recorded in the first valid address allocation record to a first user terminal indicated by the first user terminal identifier, the method further comprises:
determining, by the control plane node, a first routing rule corresponding to the first address identifier and a gateway router; and
notifying, by the control plane node, the gateway router of the first routing rule.

4. The method according to claim 3, wherein after allocating a first address identifier recorded in the first valid address allocation record to a first user terminal indicated by the first user terminal identifier, the method further comprises:
determining, by the control plane node, N1 routing rules corresponding to the first address identifier and N1 OpenFlow switches; and
sending, by the control plane node, the N1 routing rules to the N1 OpenFlow switches, wherein a routing rule sent to each OpenFlow switch of the N1 OpenFlow switches is a routing rule in the N1 routing rules that is in a one-to-one correspondence with each OpenFlow switch, the N1 OpenFlow switches are OpenFlow switches located on a transmission path between the gateway router and the first user plane access node, and N1 is a positive integer.

5. The method according to claim 1, wherein after allocating a first address identifier recorded in the first valid address allocation record to a first user terminal indicated by the first user terminal identifier, the method further comprises:
determining, by the control plane node, a second routing rule corresponding to the first address identifier and the first user plane access node; and
notifying, by the control plane node, the first user plane access node of the second routing rule.

6. The method according to claim 1, wherein after sending, to the first user plane access node by the control plane node, a first request response message in response to the first service request message, the method further comprises:
receiving, by the control plane node, a second service request message that is from a second user plane access node and that carries the first user terminal identifier, wherein the second service request message is an access request message or a handover request message, and the second user plane access node and the first user plane access node belong to networks of different standards;
if the first valid address allocation record that matches the first user terminal identifier is found in the stored valid address allocation record, allocating, by the control plane node, the first address identifier recorded in the first valid address allocation record to the first user terminal; and
sending, to the second user plane access node by the control plane node, a second request response message in response to the second service request message, wherein the second request response message carries the first address identifier, so that the second user plane access node notifies the first user terminal of the first address identifier.

7. The method according to claim 1, further comprising:
if no valid address allocation record that matches the first user terminal identifier is found in the stored valid address allocation record, allocating, by the control plane node, a second address identifier to the first user terminal, and sending, to the first user plane access node by the control plane node, a second request response message in response to the first service request message, wherein the second request response message carries the second address identifier, so that the first user plane access node notifies the first user terminal of the second address identifier.

8. The method according to claim 7, further comprising:
generating a second valid address allocation record according to the first user terminal identifier and the second address identifier, and storing the second valid address allocation record, wherein the second valid address allocation record records the first user terminal identifier, the second address identifier, and a user plane access node identifier corresponding to the first user plane access node, or the second valid address allocation record records the first user terminal identifier and the second address identifier.

9. The method according to claim 7, wherein after allocating, by the control plane node, a second address identifier to the first user terminal, the method further comprises:
determining, by the control plane node, a third routing rule corresponding to the second address identifier and the gateway router; and
notifying, by the control plane node, the gateway router of the third routing rule.

10. The method according to claim 7, wherein after allocating, by the control plane node, a second address identifier to the first user terminal, the method further comprises:
determining, by the control plane node, a fourth routing rule corresponding to the second address identifier and the first user plane access node; and
notifying, by the control plane node, the first user plane access node of the fourth routing rule.

11. The method according to claim 7, wherein after sending, to the first user plane access node by the control plane node, a second request response message in response to the first service request message, the method further comprises:
receiving, by the control plane node, a second service request message that is from a third user plane access node and that carries the first user terminal identifier, wherein the second service request message is an access request message or a handover request message, and the third user plane access node and the first user plane access node belong to networks of a same standard or different standards;
if the second valid address allocation record that matches the first user terminal identifier is found in the stored valid address allocation record, allocating, by the control plane node, the second address identifier recorded in the second valid address allocation record to the first user terminal; and
sending, to the third user plane access node by the control plane node, a third request response message in response to the second service request message, wherein the third request response message carries the second address identifier, so that the third user plane access node notifies the first user terminal of the second address identifier.

12. A control plane node, comprising:
a receiver, configured to receive a first service request message that is from a first user plane access node and that carries a first user terminal identifier, wherein the first service request message is an access request message or a handover request message;
a processor, configured to:
search a stored valid address allocation record for a valid address allocation record that matches the first user terminal identifier, and
if a first valid address allocation record that matches the first user terminal identifier is found in the stored valid address allocation record, allocate a first address identifier recorded in the first valid address allocation record to a first user terminal indicated by the first user terminal identifier; and
a transmitter, configured to send, to the first user plane access node, a first request response message in response to the first service request message, wherein the first request response message carries the first address identifier, so that the first user plane access node notifies the first user terminal of the first address identifier.

13. The control plane node according to claim 12, wherein the first valid address allocation record further records a user plane access node identifier, wherein a user plane access node indicated by the user plane access node identifier and the first user plane access node belong to networks of a same standard, or a user plane access node indicated by the user plane access node identifier and the first user plane access node belong to networks of different standards.

14. The control plane node according to claim 12, wherein the processor is further configured to:
after the processor allocates the first address identifier recorded in the first valid address allocation record to the first user terminal indicated by the first user terminal identifier, determine a first routing rule corresponding to the first address identifier and a gateway router, and notify the gateway router of the first routing rule.

15. The control plane node according to claim 14, wherein the processor is further configured to:
after the processor allocates the first address identifier recorded in the first valid address allocation record to the first user terminal indicated by the first user terminal identifier, determine N1 routing rules corresponding to the first address identifier and N1 OpenFlow switches, and send the N1 routing rules to the N1 OpenFlow switches, wherein a routing rule sent to each OpenFlow switch of the N1 OpenFlow switches is a routing rule in the N1 routing rules that is in a one-to-one correspondence with each OpenFlow switch, the N1 OpenFlow switches are OpenFlow switches located on a transmission path between the gateway router and the first user plane access node, and N1 is a positive integer.

16. The control plane node according to claim 12, wherein the processor is further configured to:
after allocating the first address identifier recorded in the first valid address allocation record to the first user terminal indicated by the first user terminal identifier, determine a second routing rule corresponding to the first address identifier and the first user plane access node, and notify the first user plane access node of the second routing rule.

17. The control plane node according to claim 12, wherein:
the receiver is further configured to:
after the transmitter sends, to the first user plane access node, the first request response message in response to the first service request message, receive a second service request message that is from a second user plane access node and that carries the first user terminal identifier, wherein the second service request message is an access request message or a handover request message, and the second user plane access node and the first user plane access node belong to networks of different standards;
the processor is further configured to:
if the first valid address allocation record that matches the first user terminal identifier is found in the stored valid address allocation record, allocate the first address identifier recorded in the first valid address allocation record to the first user terminal; and
the transmitter is further configured to:
send, to the second user plane access node, a second request response message in response to the second service request message, wherein the second request response message carries the first address identifier, so that the second user plane access node notifies the first user terminal of the first address identifier.

18. The control plane node according to claim 12, wherein:
the processor is further configured to:
if no valid address allocation record that matches the first user terminal identifier is found in the stored valid address allocation record, allocate a second address identifier to the first user terminal; and
the transmitter is further configured to:
send, to the first user plane access node, a second request response message in response to the first service request message, wherein the second request response message carries the second address identifier, so that the first user plane access node notifies the first user terminal of the second address identifier.

19. The control plane node according to claim 18, wherein:
the processor is further configured to:
generate a second valid address allocation record according to the first user terminal identifier and the first address identifier; and
the control plane node further comprises:
a memory, the memory is configured to store the second valid address allocation record, wherein the second valid address allocation record records the first user terminal identifier, the first address identifier, and a user plane access node identifier corresponding to the first user plane access node, or the second valid address allocation record records the first user terminal identifier and the first address identifier.

20. The control plane node according to claim 18, wherein the processor is further configured to:
after allocating the second address identifier to the first user terminal, determine a third routing rule corresponding to the second address identifier and the gateway router, and notify the gateway router of the third routing rule.
